(19) United States
(12) Patent Application Publication
(10) Pub. No.: US 2021/0378241 A1
(43) Pub. Date: Dec. 9, 2021

(54) COMBINATION COMPRISING A BENZAMIDE HERBICIDE AND A PYRIDINE CARBOXYLIC ACID HERBICIDE, AND A METHOD FOR MAKING AND USING THE COMBINATION

(71) Applicant: Generic Crop Science LLC, Henderson, NV (US)

(72) Inventors: Shiv Sharma, Houston, TX (US); Joe Middione, JR., Henderson, NV (US); Samuel Robert McClinton, Henderson, NV (US)

(73) Assignee: Generic Crop Science LLC, Henderson, NV (US)

(21) Appl. No.: 17/331,248

(22) Filed: May 26, 2021

Related U.S. Application Data
(60) Provisional application No. 63/034,082, filed on Jun. 3, 2020.

(51) Int. Cl. A01N 43/50; A01N 37/18

(52) U.S. Cl. CPC A01N 43/50; A01N 37/18

(57) ABSTRACT

Certain disclosed embodiments concern a combination, particularly a composition, comprising a benzamide compound having a formula

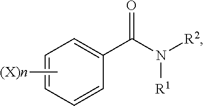

and a pyridine carboxylic acid compound having a formula

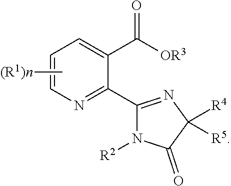

Particular compositions comprise, consist of, or consist essentially of, Pronamide and Imazethapyr. Disclosed compositions may further comprise, for example, a pH adjustor, a surfactant, a safener, a dispersing agent, water, an organic co-solvent, an anti-freezing agent, a defoamer, a preservative, a filler, a rheology aid, an odorant, at least one additional co-herbicide, and any and all combinations thereof. The present invention also concerns a method comprising applying a suitable combination or composition to a locus comprising plants, such as alfalfa, and a method for making disclosed compositions.

### CROSS REFERENCE TO RELATED APPLICATION

The present application claims the benefit of the earlier filing date of U.S. Provisional Application No. 63/034,082, filed on Jun. 3, 2020, which application is incorporated herein by reference in its entirety.

### FIELD

This application concerns embodiments of an herbicidal combination or composition comprising at least a benzamide, such as Pronamide and/or analogs thereof, and a pyridine carboxylic acid, such as Imazethapyr and/or analogs thereof, and a method for making and using such composition.

### BACKGROUND

Pronamide, 3,5-dichloro-n-(1,1-dimethyl-2-propynyl) benzamide, also referred to Propyzamide (shown below), is a soil-active, systemic herbicide and the active ingredient in various commercial herbicidal formulations in amounts generally ranging from 35% to 51%. Pronamide typically is formulated as a powder or as water-dispersible granules.

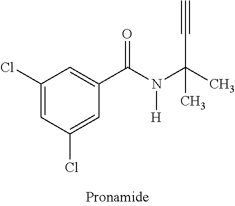 [SMILES: C#CC(C)(C)NC(=O)c1cc(Cl)cc(Cl)c1]

Pronamide prevents mitosis in grasses and broadleaf weeds, and provides selective pre- and post-emergent control of annual grasses and broadleaf weeds in a wide variety of crops, including, in the U.S., alfalfa, apples, artichokes, berries, such as blackberry, boysenberry, blueberry, cherry and raspberry, clover, endive, escarole, grape, head lettuce, nectarine, peach, pear, plum, prune, radicchio greens, rhubarb, ornamentals, and Christmas tree farms. Pronamide is also used on athletic fields, such as golf courses, stadium fields and professional athletic fields. Pronamide may have the same, additional or alternative uses in countries other than in the United States. For example, European approved uses for Pronamide include oilseed rape (winter), field bean (winter), apple, blackberry and other bush berries, pear, plum, rhubarb, strawberry, seed crops, including red clover, white clover, sugar beet, fodder rape, kale, and turnip, lettuce and forests. Pronamide application rates vary, depending on a number of factors known to a person of ordinary skill in the art, including considering particular crops, weeds/plants being controlled, soil type, and rain fall, but typically are between about 1 pint (473 milliliters) to 10 pints (4.73 liters)/acre.

Imazethapyr, 2-[4,5-dihydro-4-methyl-4-(1-methylethyl)-5-oxo-1H-imidazol-2-yl]-5-ethyl-3-pyridinecarboxylic acid (shown below), typically is used as a selective herbicide.

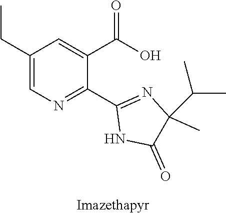 [SMILES: CCc1cnc(C2=NC(C)(C(C)C)C(=O)N2)c(C(=O)O)c1]

Imazethapyr is believed to reduce isoleucine, leucine and valine levels by inhibiting aceto-hydroxy acid synthase, which disrupts protein synthesis, DNA synthesis and cell growth. Imazethapyr is used to control grasses and broadleaved weeds, including barnyard grass, crabgrass, cocklebur, panicums, pigweeds, nightshade, mustard, smartweed, velvetleaf, jimsonweed, foxtails, seedling johnsongrass, lambsquarters, morning glory and others. Tolerant crops include soybeans, peanuts, dry and edible beans, peas, alfalfa and imidazolinone-resistant/tolerant corn. Imazethapyr may be applied preplant, preemergence, at cracking, and postemergence.

Imazethapyr has been applied at various application rates. For example, Imazethapyr has been applied at 0.05 kg ai/ha (kilogram active ingredient per hectare) to 0.14 kg ai/ha. Imazethapyr controls 90% or more of smooth pigweed regardless of application method or herbicide rate. Imazethapyr at 0.05 kg/ha controls jimsonweed 30% better postemergence compared to soil applications. Imazethapyr at 0.10 kg/ha controlled 90% or more velvetleaf regardless of the application method. Cantwell, et al., Imazethapyr for Weed Control in Soybean (Glycine Max), Weed Control, Vol. 3, pp. 596-601 (1989).

Imazethapyr, unfortunately, creates substantial plant-back and rotational crop restrictions following its use. For example, in cases of crop failure, the manufacturer recommends that the user replant only soybeans, common beans such as Phaseolus vulgaris, lima beans, adzuki beans, Imazethapyr-tolerant corn, and processing peas in the year of application. Winter wheat may also be re-planted in cases of crop failure or as a rotational crop, but only after waiting 100 days following Imazethapyr application. These restrictions substantially hinder the beneficial uses of Imazethapyr.

### SUMMARY

Disclosed embodiments of the present invention provide a novel herbicidal combination or composition that includes at least two different herbicides particularly selected to have different, but compatible, biological modes of action. Disclosed embodiments address known plant back and rotational crop restrictions associated with Imazethapyr application. One particular embodiment concerns using disclosed combinations or compositions to reduce the rate of Imazethapyr used, particularly for use with alfalfa. For example, an embodiment comprising a 3 ounce/acre rate of Imazethapyr and a 2 pint/acre rate of Pronamide provided excellent weed control in alfalfa. Currently there are approximately 10 million acres of alfalfa grown in the United States.

Certain disclosed embodiments concern a combination or composition comprising a benzamide compound and a pyridine carboxylic acid compound. Benzamide compounds according to the disclosure may have a formula as indicated below

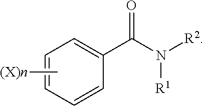

With reference to this formula, R¹ is hydrogen or C₁-C₆ alkyl; R² is an aliphatic alkyne; X is halogen, such as chlorine, and n=1, 2, 3, 4, or 5, more typically 1 or 2, and preferably n=2 with X at the 3 and 5 positions, as indicated below

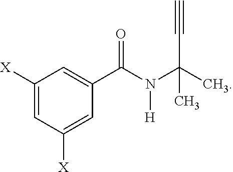

Pyridine carboxylic acid compounds according to the disclosure may have a formula

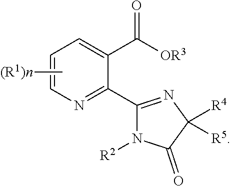

With reference to this formula, R¹ is alkyl, typically lower alkyl, such as C₁₋₆ alkyl, and n=1, 2, or 3, more typically 1 or 2, and preferably n=1. R² is hydrogen or alkyl. R³ is hydrogen, a charged species that forms a salt, or is aliphatic. And R⁴ and R⁵ are independently C₁₋₆ alkyl. Preferred compounds have the following formula with n=1 and R¹ generally in the position indicated.

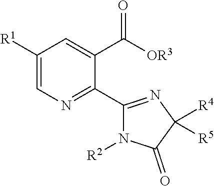

For certain embodiments, X for the benzamide compound is chlorine; n for the benzamide compound is 2; R¹ for the benzamide compound is hydrogen; and/or R² for the benzamide compound is 1,1-dimethyl-2-propynyl. For particular embodiments the benzamide compound is Pronamide.

For certain embodiments, R¹ for the pyridine carboxylic acid compound is C₁₋₆ alkyl, such as methyl, ethyl, propyl, butyl, pentyl or hexyl, including branched and substituted analogs thereof; R² for the pyridine carboxylic acid compound is hydrogen or alkyl, particularly C₁₋₆ alkyl; and/or R³ for the pyridine carboxylic acid compound is hydrogen, a cationic metal species that forms a salt with the carboxylic acid functional group, an ammonium salt, a cationic organic species that forms a salt with the carboxylic acid functional group, or C₁₋₆ alkyl. For certain embodiments, the pyridine carboxylic acid compound is Imazethapyr.

Particular compositions according to the present invention comprise 3,5-dichloro-n-(1,1-dimethyl-2-propynyl) benzamide (Pronamide)

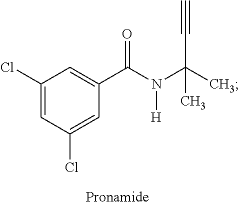 [SMILES: C#CC(C)(C)NC(=O)c1cc(Cl)cc(Cl)c1]

and 2-[4,5-dihydro-4-methyl-4-(1-methylethyl)-5-oxo-1H-imidazol-2-yl]-5-ethyl-3-pyridinecarboxylic acid (Imazethapyr)

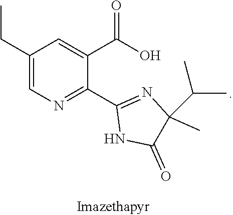 [SMILES: CCc1cnc(C2=NC(C)(C(C)C)C(=O)N2)c(C(=O)O)c1]

A person of ordinary skill in the art will appreciate that the benzamide compound and the pyridine carboxylic acid compound can be used in combination, and applied simultaneously as separate mixes, or applied sequentially in any order, or the benzamide compound and the pyridine carboxylic acid compound can be combined in any of various relative amounts to form useful herbicidal compositions, such as either a premix concentrate or as a tank mix. For example, certain embodiments comprise from 1:1 to at least 1:12 by volume of the pyridine carboxylic acid to the benzamide. Relative amounts also can be specified as percentages, typically weight percents. Accordingly, certain disclosed embodiments of the present invention comprise from about 1 wt. % to about 2 wt. % of the pyridine carboxylic acid, such as Imazethapyr, with one particular embodiment comprising 1.7 wt. % Imazethapyr (99.74%), and from about 30 wt. % to about 40 wt. % of the benzamide, such as Pronamide, with one particular embodiment comprising 33 wt. % Pronamide (Propyzamide technical, 97.5%). The composition can be formulated as a powder or granules, or can be formulated as an aqueous and/or organic solution or suspension.

Combinations and compositions according to the present invention can also include additional components, such as a pH adjustor, a surfactant, a safener, a dispersing agent, water, an organic co-solvent, an anti-freezing agent, a defoamer, a preservative, a filler, a rheology aid, an odorant, at least one additional co-herbicide, and any and all combinations thereof. One particular aqueous composition comprised from 38 wt. % to 39 wt. % water; 1 wt. % to 2 wt. % hexylene glycol as a co-solvent; 0.1 wt. % to 1 wt. % xanthan gum; 0.1 wt. % to 1 wt. % Aciticide; 0.1 wt. % to 1 wt. % SAG 1572; 33 wt. % to 35 wt. % Pronamide; and 1 wt. % to 2 wt. % Imazethapyr. One additional embodiment comprised this same composition and amounts, and further comprised 20 wt. % to 30 wt. % of adjuvant AU-760B, from Adjuvants Unlimited. With reference to co-herbicides, a person of ordinary skill in the art will appreciate that disclosed combinations or compositions may further comprise any known herbicide or herbicide subsequently identified. For example, disclosed combinations or compositions may further comprise Glyphosate (N-(phosphonomethyl) glycine), Pendimethalin (3,4-Dimethyl-2,6-dinitro-N-pentan-3-yl-aniline), or both. As another example, disclosed combinations or compositions may include at least one additional alfalfa product for pre- or post-application, such as Buctril (active ingredient=bromoxynil, 3,5-bibromo-4-hydroxybenzonitrile), 2,4-DB, POAST (active ingredient=sethoxydim; 2-[1-(ethoxyimino)butyl]-5-[2-(ethylthio)propyl]-3-hydroxy-2-cyclohexen-1-one), POAST PLUS (active ingredient=sethoxydim), Prism (active ingredient=rimsulfuron, N-[(4,6-dimethoxypyrimidin-2-yl)carbamoyl]-3-(ethylsulfonyl)pyridine-2-sulfonamide or 1-(4,6-dimethoxypyrimidin-2-yl)-3-{[3-(ethylsulfonyl)-2-pyridyl]sulfonyl}urea) and Select (active ingredient=clethodim, (5RS)-2-{(E)-1-[(2E)-3-chloroallyloxyimino]propyl}-5-[(2RS)-2-(ethylthio)propyl]-3-hydroxycyclohex-2-en-1-one).

Certain more particular embodiments of the present invention concern a binary composition with reference to the primary active ingredients, such as a composition that consists of, or consists essentially of, a benzamide herbicide and a pyridine carboxylic acid herbicide. Even more particular embodiments concern a composition that consists of, or consists essentially of, Pronamide and Imazethepyr. As used in this context, “consists of” or “consists essentially of” is intended to refer solely to the active ingredients, also perhaps referred to in the field as the technicals, that are used to form such compositions. That is, such terms are intended to limit certain disclosed compositions to just a benzamide herbicide and a pyridine carboxylic acid herbicide, and more particularly to just Pronamide and Imazethepyr, as the active technical components. Other components typically used to form herbicidal compositions can be included, and therefore are not necessarily excluded by, “consists of” or “consists essentially of,” such as, solely by way of example and without limitation, adjuvants, surfactants, safeners, etc., unless the context clearly indicates such additional components are intended to be excluded.

The present invention also concerns a method for using disclosed combinations or compositions. The method comprises applying disclosed benzamide and pyridine carboxylic acid herbicides in combination, or applying disclosed compositions, to a locus of planted crops, to plants, to soil about the plants, or to an acceptable soil depth in soil in which plants are growing, or combinations thereof, where undesirable vegetation occurs or might occur or to a locus where crops will be planted before planting or emergence of the crop. The composition may be applied preplant, preemergence, at cracking, and postemergence, and can be used to control undesirable vegetation, such as broadleafs, grass weeds and sedges. The composition may be particularly suitable for use with soybeans, peanuts, dry and edible beans, peas, alfalfa, and imidazolinone-resistant/tolerant corn.

A method for making suitable composition embodiments according to the present invention also is disclosed. The method comprises making a premix concentrate or a tank mix comprising an effective amount of at least (1) a benzamide compound having a formula

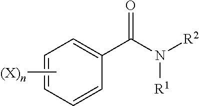

where R¹ is hydrogen or C₁-C₆ alkyl, R² is an aliphatic alkyne, X is halogen, and n=1 or 2, and (2) a pyridine carboxylic acid compound having a formula

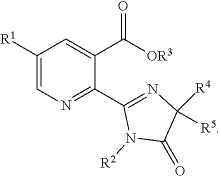

where R¹ is alkyl, R² is hydrogen or alkyl, R³ is hydrogen, a salt, or aliphatic, and R⁴ and R⁵ are independently C₁₋₆ alkyl.

The foregoing and other objects, features, and advantages of the invention will become more apparent from the following detailed description, which proceeds with reference to the accompanying figures.

### BRIEF DESCRIPTION OF THE DRAWINGS

FIG. 1 is a graph of percent burndown versus time for the trials discussed in Example 3.

FIG. 2 is a graph of weed density (counts per yard) versus time for the trials discussed in Example 3.

FIG. 3 is a bar graph illustrating percent burndown and weed density (counts per yard²) for various formulations versus a control 6 days after application for the trials discussed in Example 3.

FIG. 4 is a bar graph illustrating percent burndown and weed density (counts per yard²) for various formulations versus a control 6 days after application for the trials discussed in Example 3.

FIG. 5 is a bar graph illustrating percent burndown and weed density (counts per yard²) for various formulations versus a control 13 days after application for the trials discussed in Example 3.

FIG. 6 is a bar graph illustrating percent burndown and weed density (counts per yard²) for various formulations versus a control 13 days after application for the trials discussed in Example 3.

FIG. 7 is a bar graph illustrating percent burndown and weed density (counts per yard²) for various formulations versus a control 20 days after application for the trials discussed in Example 3.

FIG. 8 is a bar graph illustrating percent burndown and weed density (counts per yard²) for various formulations versus a control 20 days after application for the trials discussed in Example 3.

FIG. 9 is a bar graph illustrating percent burndown and weed density (counts per yard²) for various formulations versus a control 27 days after application for the trials discussed in Example 3.

FIG. 10 is a bar graph illustrating percent burndown and weed density (counts per yard²) for various formulations versus a control 27 days after application for the trials discussed in Example 3.

FIG. 11 is a bar graph illustrating percent burndown and weed density (counts per yard²) for various formulations versus a control 34 days after application for the trials discussed in Example 3.

FIG. 12 is a bar graph illustrating percent burndown and weed density (counts per yard²) for various formulations versus a control 34 days after application for the trials discussed in Example 3.

FIG. 13 is a bar graph summarizing field trial results based on percent weed control versus treatment, days after treatment and weeds controlled.

FIG. 14 is a bar graph summarizing field trial results based on percent weed control versus treatment, days after treatment and weeds controlled.

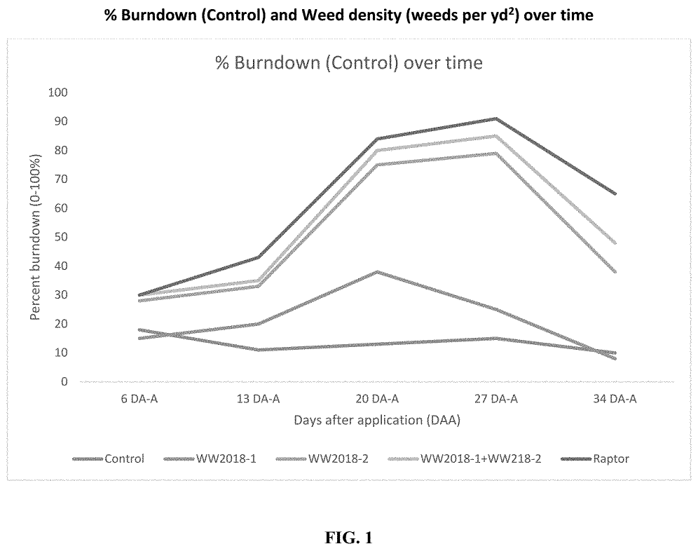

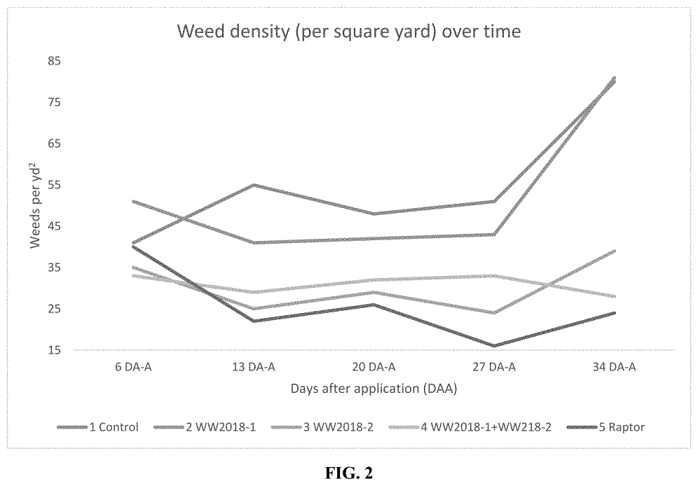

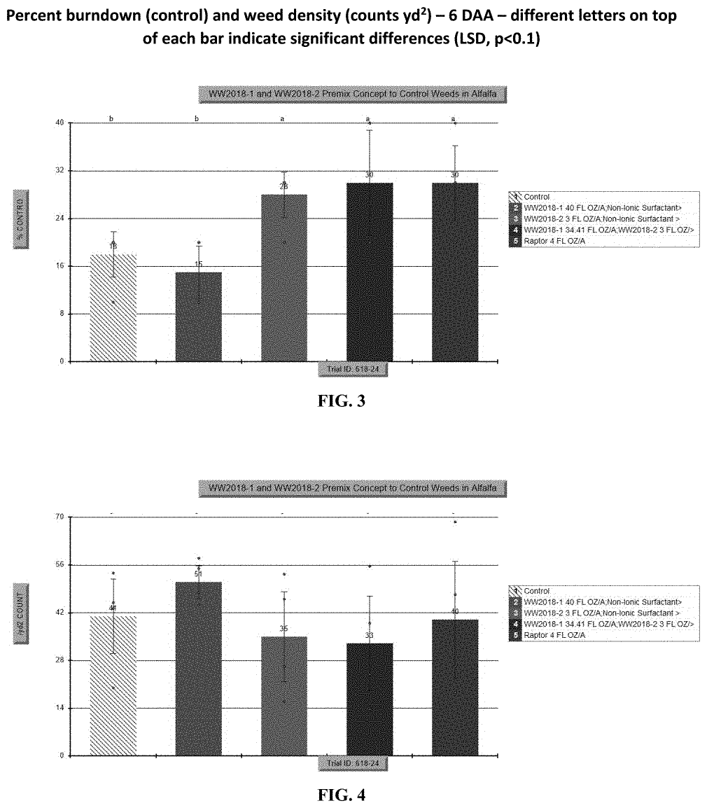

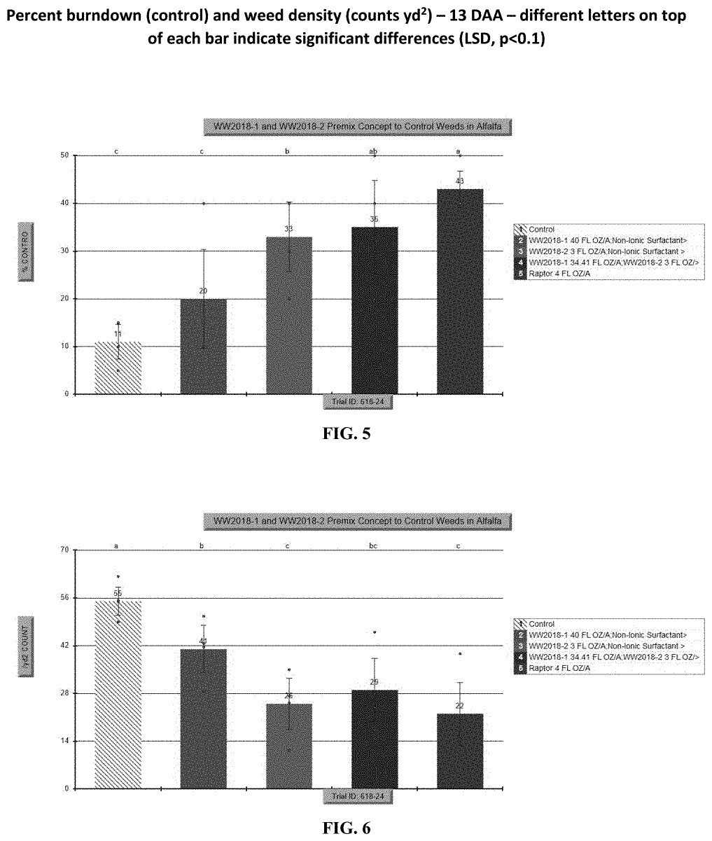

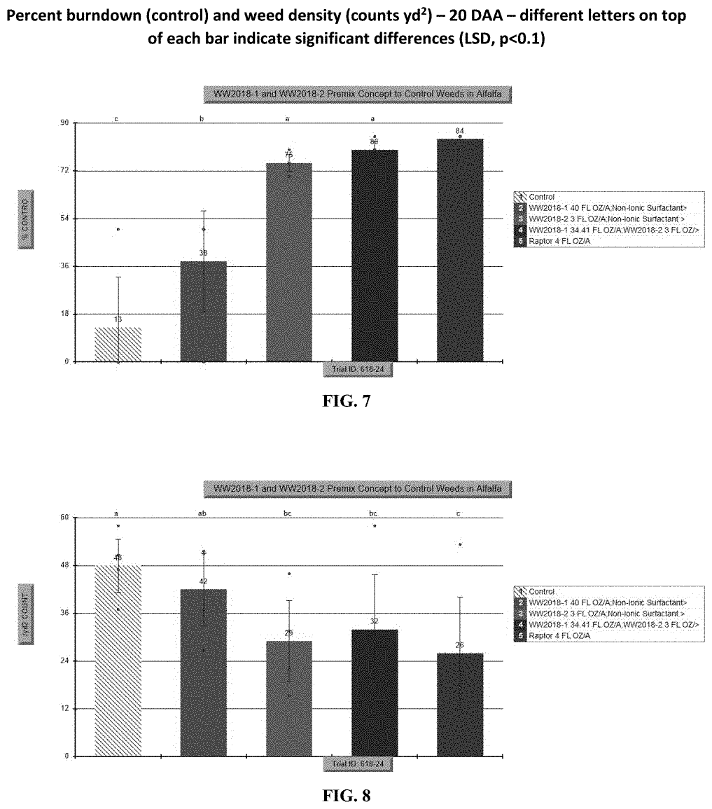

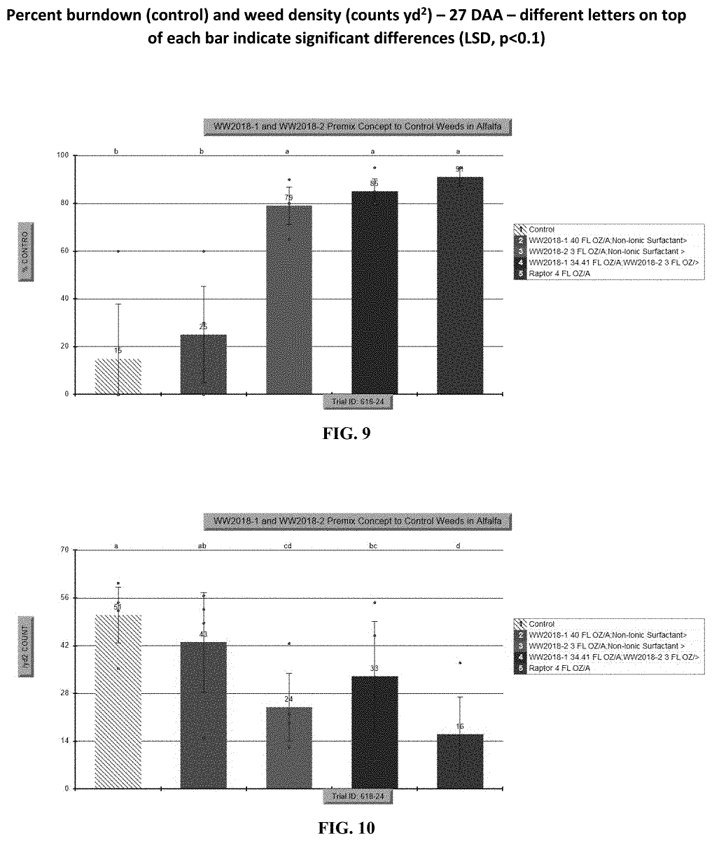

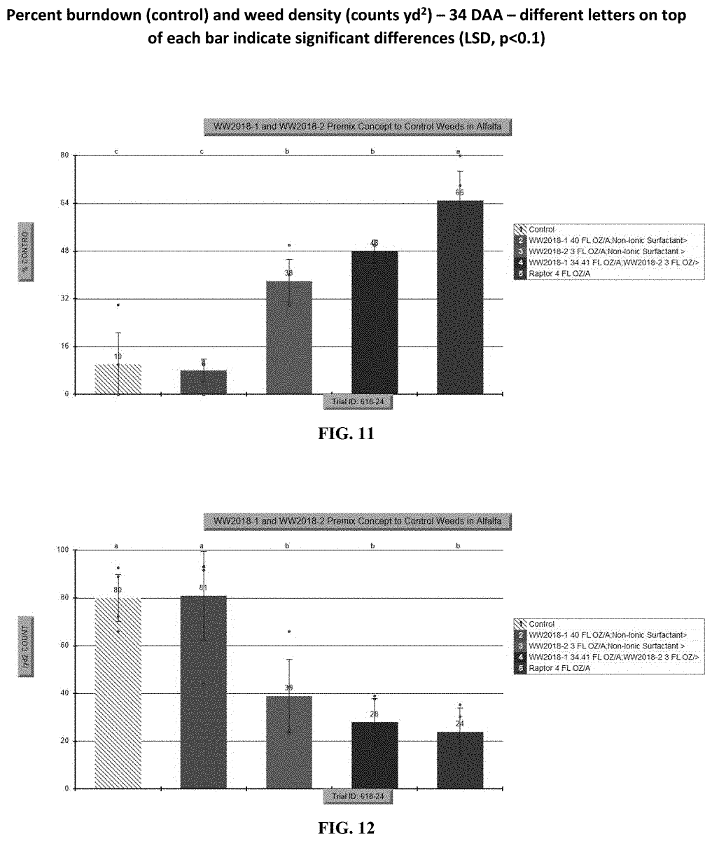

### DETAILED DESCRIPTION

### I. Definitions

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood by one of ordinary skill in the art to which this disclosure pertains. Although methods and materials similar or equivalent to those described herein can be used to practice or test disclosed subject matter, suitable methods and materials are described below. The materials, methods, and examples are illustrative only and are not intended to be limiting. Other features of the disclosure will be apparent to a person of ordinary skill in the art from the following detailed description and the claims.

The disclosure of numerical ranges includes written description for each and every discrete point within the range, inclusive of endpoints, unless otherwise noted.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods known to those of ordinary skill in the art. When directly and explicitly distinguishing embodiments from discussed prior art, the embodiment numbers are not approximates unless the word “about” is expressly recited.

Although alternatives for various components, parameters, operating conditions, etc., may be set forth herein, this does not mean that such alternatives are necessarily equivalent and/or perform equally well. Nor does it mean that the alternatives are listed in a preferred order unless stated otherwise.

In order to facilitate review of the various embodiments of the disclosure, the following explanations of specific terms are provided:

Acceptable salt: A compatible salt of a compound, such as a carboxylic acid, that can be that can be used for an intended pesticidal/herbicidal purpose, which salts are derived from a variety of organic and inorganic counter ions well known in the art and include, by way of example only, sodium, potassium, calcium, magnesium, ammonium, tetraalkylammonium, and the like; and when the molecule contains a basic functionality, salts of organic or inorganic acids, such as hydrochloride, hydrobromide, tartrate, mesylate, acetate, maleate, oxalate, and the like. Acceptable acid addition salts are those salts that retain the effectiveness of the free bases while formed by acid partners that are not biologically or otherwise undesirable, e.g., inorganic acids such as hydrochloric acid, hydrobromic acid, sulfuric acid, nitric acid, phosphoric acid, and the like, as well as organic acids such as acetic acid, trifluoroacetic acid, propionic acid, glycolic acid, pyruvic acid, oxalic acid, maleic acid, malonic acid, succinic acid, fumaric acid, tartaric acid, citric acid, benzoic acid, benzene sulfonic acid (besylate), cinnamic acid, mandelic acid, methanesulfonic acid, ethanesulfonic acid, p-toluenesulfonic acid, salicylic acid and the like. Acceptable base addition salts include those derived from inorganic bases such as sodium, potassium, lithium, ammonium, calcium, magnesium, iron, zinc, copper, manganese, aluminum salts and the like. Exemplary salts are the ammonium, potassium, sodium, calcium, and magnesium salts. Salts derived from organic non-toxic bases include, but are not limited to, salts of primary, secondary, and tertiary amines, substituted amines including naturally occurring substituted amines, cyclic amines and basic ion exchange resins, such as isopropylamine, trimethylamine, diethylamine, triethylamine, tripropylamine, ethanolamine, 2-dimethylaminoethanol, 2-diethylaminoethanol, dicyclohexylamine, lysine, arginine, histidine, caffeine, procaine, hydrabamine, choline, betaine, ethylenediamine, glucosamine, methylglucamine, theobromine, purines, piperazine, piperidine, N-ethylpiperidine, polyamine resins, and the like. Exemplary organic bases are isopropylamine, diethylamine, ethanolamine, trimethylamine, dicyclohexylamine, choline, and caffeine. (See, for example, S. M. Berge, et al., “Pharmaceutical Salts,” J. Pharm. Sci., 1977; 66:1-19, which is incorporated herein by reference.) Aliphatic: A substantially hydrocarbon-based compound, or a radical thereof (e.g., C₆H₁₃, for a hexane radical), including alkanes, alkenes, alkynes, including cyclic versions thereof, and further including straight- and branched-chain arrangements, and all stereo and position isomers as well. Unless expressly stated otherwise, an aliphatic group contains from one to twenty-five carbon atoms (C₁-C₂₅); for example, from one to fifteen, from one to ten, from one to six, or from one to four carbon atoms. The term “lower aliphatic” refers to an aliphatic group containing from one to ten carbon atoms. An aliphatic chain may be substituted or unsubstituted. Unless expressly referred to as an “unsubstituted aliphatic,” an aliphatic group can either be unsubstituted or substituted. An aliphatic group can be substituted with one or more substituents (up to two substituents for each methylene carbon in an aliphatic chain, or up to one substituent for each carbon of a C═C double bond in an aliphatic chain, or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, or other functionality.

Alkoxy: A radical (or substituent) having the structure —OR, where R is a substituted or unsubstituted alkyl. Methoxy (OCH₃) is an exemplary alkoxy group. In a substituted alkoxy, R is alkyl substituted with a non-interfering substituent. “Thioalkoxy” refers to —S—R, where R is substituted or unsubstituted alkyl. “Haloalkyloxy” means a radical OR where R is a haloalkyl.

Alkyl: A hydrocarbon group having a saturated carbon chain. The chain may be cyclic, branched or unbranched. Examples, without limitation, of alkyl groups include methyl, ethyl, propyl, butyl, pentyl, hexyl, heptyl, octyl, nonyl and decyl. The term lower alkyl means the chain includes 1-10 carbon atoms. The terms alkenyl and alkynyl refer to hydrocarbon groups having carbon chains containing one or more double or triple bonds, respectively.

Alkylamino: A chemical functional group —N(H)R, where R is an alkyl group.

Alkylammonium: A cation having a formula [N(H)(R′)₃]+ where each R′ independently is H or alkyl.

Alkynyl: A hydrocarbon group having at least one triple bond.

Amide: An organic compound characterized by a carbonyl group (C═O) linked to a nitrogen atom and having the following general formula, where R, R′ and R″ are the same or different, and typically are selected from hydrogen, aliphatic, and aryl.

Amido: A chemical functional group —C(O)N(R)(R′) where R and R′ are independently hydrogen, alkyl, heteroalkyl, haloalkyl, aliphatic, heteroaliphatic, aryl (such as optionally substituted phenyl or benzyl), heteroaryl, alkylsulfano, or other functionality.

Amino: A chemical functional group —N(R)R′ where R and R′ are independently hydrogen, alkyl, heteroalkyl, haloalkyl, aliphatic, heteroaliphatic, aryl (such as optionally substituted phenyl or benzyl), heteroaryl, alkylsulfano, or other functionality. A “primary amino” group is NH₂. “Mono substituted amino” means a radical —N(H)R substituted as above and includes, e.g., methylamino, (1-methylethyl)amino, phenylamino, and the like. “Di substituted amino” means a radical —N(R)R′ substituted as above and includes, e.g., dimethylamino, methylethylamino, di(1 methylethyl)amino, and the like.

Aralkyl/arylalkyl: An aryl group (such as a phenyl group) appended to an alkyl radical including, but not limited to, benzyl, ethylbenzene, propylbenzene, butylbenzene, pentylbenzene, and the like. Conversely the term “phenylalkyl” refers to a phenyl group appended to an alkyl radical. Aralkyl groups, such as benzyl groups, may be unsubstituted or substituted with one, two or three substituents, with substituent(s) independently selected from alkyl, heteroalkyl, aliphatic, heteroaliphatic, thioalkoxy, haloalkyl (such as CF₃), halo, nitro, cyano, OR (where R is hydrogen or alkyl), N(R)R′ (where R and R′ are independently of each other hydrogen or alkyl), COOR (where R is hydrogen or alkyl) or —C(O)N(R′)R″ (where R′ and R″ are independently selected from hydrogen or alkyl). Non limiting examples, include o, m, and/or p chlorobenzyl, o, m, and/or p methoxybenzyl, and o, m, and/or p (trifluoromethyl)benzyl.

Aromatic: Unsaturated, cyclic hydrocarbons having alternate single and double bonds. Benzene, a 6-carbon ring containing three double bonds, is a typical aromatic compound.

Aryl: A monovalent aromatic carbocyclic group of, unless specified otherwise, from 6 to 15 carbon atoms having a single ring (e.g., phenyl) or multiple condensed rings in which at least one ring is aromatic (e.g., quinoline, indole, benzodioxole, and the like), provided that the point of attachment is through an atom of an aromatic portion of the aryl group and the aromatic portion at the point of attachment contains only carbons in the aromatic ring. If any aromatic ring portion contains a heteroatom, the group is a heteroaryl and not an aryl. Aryl groups are monocyclic, bicyclic, tricyclic or tetracyclic.

Arylalkyl: An acyclic alkyl group in which one of the hydrogen atoms bonded to a carbon atom, typically a terminal or sp3 carbon atom, is replaced with an aryl group. Typical arylalkyl groups include, but are not limited to, benzyl, 2-phenylethan-1-yl, naphthylmethyl, 2-naphthylethan-1-yl, naphthobenzyl, 2-naphthophenylethan-1-yl and the like. Where specific alkyl moieties are intended, the nomenclature arylalkanyl, arylalkenyl and/or arylalkynyl may be used.

Carboxyalkyl: A functional group with the formula —COOR where R is alkyl.

Carboxyl: A COOH radical. Substituted carboxyl refers to COOR where R is aliphatic, heteroaliphatic, alkyl, heteroalkyl, or a carboxylic acid or ester.

Carboxylic Acid: A carbonyl-bearing functional group having a formula RCOOH where R is aliphatic, heteroaliphatic, alkyl, or heteroalkyl.

Combination: A combination comprises two or more active components that are used, such as being applied to a plant or plant locus, wherein the effective time period of the first component overlaps with the effective time period of the second and subsequent components. A combination may be a composition comprising the components, or it may be two or more individual components administered substantially simultaneously, or sequentially in any order

Derivative or Analog: A compound that is derived from a similar compound or a compound that can be imagined to arise from another compound, for example, if one atom or functional group is replaced with another atom or functional group.

Ester: A chemical compound derived from an organic acid (general formula: RCO₂H) where the hydrogen of the —OH (hydroxyl) group is replaced by virtually any group, including aliphatic, substituted aliphatic, aryl, arylalkyl, heteroaryl, etc. Functional Group: A specific group of atoms within a molecule that is responsible for the characteristic chemical reactions of the molecule. Exemplary functional groups include, without limitation, alkyl, alkenyl, alkynyl, aryl, halo (fluoro, chloro, bromo, iodo), epoxide, hydroxyl, carbonyl (ketone), aldehyde, carbonate ester, carboxylate, carboxyl, ether, ester, peroxy, hydroperoxy, carboxamide, amino (primary, secondary, tertiary), ammonium, imide, azide, cyanate, isocyanate, thiocyanate, nitrate, nitrite, nitrile, nitroalkyl, nitroso, pyridyl, phosphate, sulfonyl, sulfide, thiol (sulfhydryl), disulfide.

Herbicide: an active ingredient that kills, controls or otherwise adversely modifies the growth of plants.

Herbicidally effective or vegetation controlling amount: an amount of active ingredient which causes an adverse modifying effect to a plant, such as, deviations from natural development, killing, regulation, desiccation, retardation, etc.

Lower: Refers to organic compounds having 10 or fewer carbon atoms (C₁₋₁₀) in a chain, including all branched and stereochemical variations, particularly including methyl, ethyl, propyl, butyl, pentyl, hexyl, heptyl, octyl, nonyl, and decyl.

Plants: includes germinant seeds, emerging seedlings, plants emerging from vegetative propagules, and established vegetation.

Substituent: An atom or group of atoms that replaces another atom in a molecule as the result of a reaction. The term “substituent” typically refers to an atom or group of atoms that replaces a hydrogen atom, or two hydrogen atoms if the substituent is attached via a double bond, on a parent hydrocarbon chain or ring. The term “substituent” may also cover groups of atoms having multiple points of attachment to the molecule, e.g., the substituent replaces two or more hydrogen atoms on a parent hydrocarbon chain or ring. In such instances, the substituent, unless otherwise specified, may be attached in any spatial orientation to the parent hydrocarbon chain or ring. Exemplary substituents include, for instance, alkyl, alkenyl, alkynyl, alkoxy, alkylamino, alkylthio, acyl, aldehyde, amido, amino, aminoalkyl, aryl, arylalkyl, arylamino, carbonate, carboxyl, cyano, cycloalkyl, dialkylamino, halo, haloaliphatic (e.g., haloalkyl), haloalkoxy, heteroaliphatic, heteroaryl, heterocycloaliphatic, hydroxyl, oxo, sulfonamide, sulfhydryl, thio, and thioalkoxy groups.

Substituted: A fundamental compound, such as an aryl or aliphatic compound, or a radical thereof, having coupled thereto one or more substituents, each substituent typically replacing a hydrogen atom on the fundamental compound. A person of ordinary skill in the art will recognize that compounds disclosed herein may be described with reference to particular structures and substituents coupled to such structures, and that such structures and/or substituents also can be further substituted, unless expressly stated otherwise or context dictates otherwise. Solely by way of example and without limitation, a substituted aryl compound may have an aliphatic group coupled to the closed ring of the aryl base, such as with toluene. Again solely by way of example and without limitation, a long-chain hydrocarbon may have a hydroxyl group bonded thereto.

%: Unless stated otherwise, all amounts stated herein concerning compositions and composition components according to the present invention are weight percents (wt. %).

### II. Benzamides

The present application concerns pesticidal, particularly herbicidal, combinations and compositions comprising at least a first halobenzamide and a second pyridine carboxylic acid, or salt or ester thereof. Certain halobenzamides have a Formula I

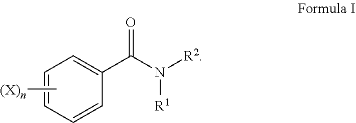

With reference to Formula I, R¹ is hydrogen or C₁-C₆ alkyl (methyl, ethyl, propyl, butyl, pentyl or hexyl, including substituted forms and all stereo and geometric isomers thereof); R² is an aliphatic alkyne or substituted alkyne; X is halogen, such as fluorine, chlorine, bromine or iodine; and n=1 to 5, more typically 1 or 2, with X at the 3 and 5 positions, as indicated below

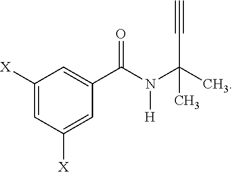

For particular embodiments R¹ is hydrogen; R² is 1,1-dimethyl-2-propynyl; X is Cl; and/or n is 2.

In particularly preferred embodiments, the halobenzamide is Pronamide. Without being limited to a particular theory of operation, Pronamide is understood to reduce cell division (mitosis) by inhibiting proteins required for spindle fibre production.

### III. Pyridine Carboxylic Acids

Pyridine carboxylic acids, or salts or esters thereof, useful for the present invention typically have a Formula 2

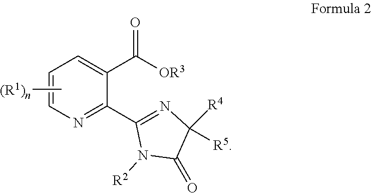

With reference to Formula 2, R¹ is alkyl, particularly C₁₋₆ alkyl (methyl, ethyl, propyl, butyl, pentyl or hexyl, including substituted forms and all stereo and geometric isomers thereof); R² is hydrogen or alkyl, particularly C₁₋₆ alkyl. R³ is hydrogen, or is part of an aliphatic ester, particularly an alkyl ester, such as C₁₋₆ alkyl ester, or is in the form of a salt, such as a metal salt, an ammonium salt, or an organic salt, such as an amine salt, with the carboxylate functional group. R⁴ and R⁵ are independently aliphatic, and more particularly are independently alkyl, such as C₁₋₆ alkyl.

For particular embodiments R¹ is ethyl; R² is hydrogen; R³ is hydrogen; and/or R⁴ and R⁵ are methyl and isopropyl.

In even more particular embodiments, the pyridine carboxylic acid is Imazethapyr. Without being limited to a theory of operation, Imazethapyr is understood to inhibit acetolactate synthase (an ALS inhibitor), a common enzyme in the biosynthesis of the branched-chain amino acids valine, leucine, and isoleucine.

Imazethapyr may be used as a salt. Certain particular embodiments use ammonium salts of Imazethapyr.

### IV. Compositions/Combinations Comprising Pronamide, and Analogs Thereof, and Imazethapyr, and/or Analogs Thereof

Compositions according to the present invention comprise effective amounts of two different active herbicides according to Formulas 1 and 2 above. The active herbicides typically are selected to have different, non-antagonistic modes of action when used together in a combination or as an herbicidal formulation.

One embodiment of a disclosed composition comprises appropriate effective amounts of Pronamide, or analogs thereof, and further comprises appropriate effective amounts of Imazethapyr, or analogs thereof. For certain embodiments, compositions according to the present invention may comprise substantially equal (1:1) by either weight or volume, typically weight, of Pronamide, or analogs thereof, and Imazethapyr, or analogs thereof. However, one significant benefit associated with the presently disclosed compositions is to reduce the currently suggested Imazethapyr application rate that is required to obtain desired results, such as weed control, and thereby also reduce certain concomitant deleterious effects associated with this application rate. For example, the amount of Imazethapyr, or analog thereof, that is used can be reduced to address known plant back and rotational crop restrictions when used at an approved application rate of 4 fluid ounces/acre without sacrificing herbicidal efficacy.

Certain disclosed compositions can be described with reference to the relative amounts of Imazethapyr, or analogs thereof, to Pronamide, or analogs thereof (Imazethapyr:Pronamide). For example, certain embodiments comprise compositions comprising from 1 part Imazethapyr to 1 part Pronamide, but more typically 1 part Imazethapyr up to at least 20 parts Pronamide (1:20 Imazethapyr:Pronamide). One particular embodiment used for field trials comprised 2.8 fluid ounces of Imazethapyr and 32 fluid ounces of Pronamide, i.e. 1:11.4 Imazethapyr:Pronamide per acre applied.

Compositions according to the present invention also can be described with reference to the percent of Imazethapyr, or analogs thereof, and Pronamide, or analogs thereof, in the total composition. For example, certain embodiments included: about 1 wt. % to about 3 wt. % Imazethapyr, such as from about 1.25 wt. % to about 2.25 wt. % Imazethapyr, with one embodiment comprising 1.7 wt. % of Imazethapyr (99.74%); and from about 20 wt. % to about 50 wt. % weight of Pronamide, such as from 30 wt. % to about 40 wt. % by weight of Pronamide, with one embodiment comprising 33.33 wt. % Pronamide (propyzamide, technical, 97.5%) by weight. However, a person of ordinary skill in the art will appreciate that herbicidal compositions according to the present invention can comprise any actual amounts of Imazethapyr and Pronamide, and any relative amounts thereof, that are best suited for particular applications.

Compositions according to the present disclosure may be formulated for retail sale, such as a concentrated premix, that can be diluted by the end user to provide a substantially diluted formulation for application or can be part of a tank mix that is mixed by a user just prior to application. For example, initial compositions can be diluted by forming either an aqueous and/or an organic (e.g. using an alcohol, glycol or ether diluent and/or solvent) diluted product, using a dilution factor as may be required or desired for particular applications, including a dilution factor of from 1 to at least 1,000, such as from 100 to 350, and perhaps more typically 150 to 320 by weight. The dilution rate may also depend on how the initial composition is used or applied. With reference to certain exemplary embodiments: for a ground application, the product may be mixed in 20 gallons of water to spray over an acre; for aerial application, the product may be mixed in a lesser amount, such as 3 gallons of water for an acre spray; and the composition may be applied at higher dilution rates by chemigation through an irrigation system.

### V. Additional Formulation Additives

A. Miscellaneous Components

A person of ordinary skill in the art will appreciate that disclosed compositions can be formulated as aqueous formulations or organic formulations, and may further include additional components to meet various different formulation requirements. For example, disclosed compositions may include one or more additives to improve the biological performance of the composition, such as, for example, by improving wetting, retention or distribution on plant surfaces; or to improve uptake or mobility of the active compounds. Additional exemplary components that can be used to make formulations according to the present invention include, by way of example and without limitation:

microbiocides, such as to control bacteria and fungi in containers, with suitable exemplary microbiocides comprising isothiazolinones, such as Acticide LA 1206, which comprises 2-bromo-2-nitropropane-1,3 diol, 4-chloro-2-methyl-4-isothazolin-3-one and 2-methyl-4-isothiazoline-3-one as active ingredients. Microbicides are used in disclosed composition embodiments at an inclusion percentage of from greater than 0% to at least 1% of the total composition by weight, typically 0.1% to 0.2%;

pH adjustors, which are added at amounts required to obtain desired formulation pHs. pH adjusters include both inorganic and organic acids and bases, such as mineral acids and bases, including sodium hydroxide, potassium hydroxide, ammonium hydroxide, hydrochloric acid and sulfuric acid;

surfactants, such as sulphosuccinates, including sodium dioctylsulfphosuccinate, in an amount of greater than 0% up to at least 3%, and typically about 2%;

dispersing agents, such as ethoxylated aryl compounds, including tristyrylphenol as an example, in an amount of greater than 0% up to at least 5%, and typically about 4%;

solvents and co-solvents, such as water and/or organic solvents, including alcohols and glycols, particularly C₁₋₁₀ alcohols or glycols, such as isobutyl alcohol and hexylene glycol, and ethers, including ethoxylated compounds. Certain embodiments according to the present invention included greater than 0% up to at least 40% water, such as from about 25% to about 40% by weight water. Certain disclosed embodiments included greater than 0% up to at least 10% by weight hexylene glycol, such as from 1% to 9% hexylene glycol;

anti-freezing agents, such as alkyl glycols, including propylene glycol, in an amount of from greater than 0% by weight to at least 5% by weight, such as 4%;

defoamers, such as silicone antifoam emulsions, for example polydimethylsiloxanes, with one particular antifoaming agent comprising SAG 1572, which is added at an effective amount of from greater than 0% to at least 1% of the total composition, such as 0.1% to 0.5%;

preservatives, such as Proxel GXL, in an amount of from greater than 0% to at least 1% by weight, such as 0.1% by weight;

fillers, such as silica, including precipitated silica, in an amount of from greater than 0% to at least 2%;

rheology aids, such as xanthan gum, in an amount of from greater than 0% to at least 1% of the total composition, typically from 0.2% to about 0.3%;

spray additives based on oils, for example certain mineral oils or natural plant oils (such as soybean and rape seed oil), and blends of these with other bio-enhancing adjuvants (ingredients which may aid or modify the action of the active compounds) in an amount of from greater than 0% by weight to at least 5% by weight;

wetting agents, dispersing agents and emulsifying agents may be cationic, anionic, amphoteric or non-ionic type in an amount of from greater than 0% by weight to at least 5% by weight;

cationic surface active agents, such as quaternary ammonium compounds including, for example cetyltrimethyl ammonium bromide, imidazolines and amine salts in an amount of from greater than 0% by weight to at least 5% by weight;

anionic surface active agents, fatty acid metal salts, salts of sulphuric acid aliphatic monoesters (e.g. sodium lauryl sulphate), salts of sulphonated aromatic compounds (e.g. sodium and calcium salts of dodecylbenzenesulphonate, butylnaphthalene sulphonate and sodium di-isopropyl- and tri-isopropyl-naphthalene sulphonates), phosphate esters (reaction products of fatty alcohols and phosphoric acid) (predominately mono-esters) or phosphorus pentoxide (predominately di-esters), for example the reaction between lauryl alcohol and tetraphosphoric acid; ether sulphates, alcohol ether sulphates (for example sodium laureth-3-sulphate), ether carboxylates (for example sodium laureth-3-carboxylate) in an amount of from greater than 0% by weight to at least 5% by weight;

liquid carriers, including water, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methanol, ethanol, isopropanol, amyl alcohol, ethylene glycol, propylene glycol, glycerine, N-methyl-2-pyrrolidinone, N,N-dimethyl alkylamides, dimethyl sulfoxide, liquid fertilizers. Water is generally used to dilute concentrates in an amount of from greater than 0% by weight to at least 50% by weight;

non-ionic surface active agents: including alkylene oxide condensation products, such as ethylene, propylene or butylene oxide; fatty alcohols (such as oleyl alcohol or cetyl alcohol); alkylphenols (such as octyl or nonylphenol); long chain fatty acid esters or hexitol anhydrides; condensation products of esters with ethylene oxide; block polymers (such as block polymers comprising ethylene oxide and propylene oxide); alkanolamides; and lecithins; in an amount of from greater than 0% by weight to at least 5% by weight;

suspending agents, such as colloids (including polysaccharides, polyvinylpyrrolidone or sodium carboxymethylcellulose) and swelling clays (such as bentonite or attapulgite) in an amount of from greater than 0% by weight to at least 5% by weight;

solid carriers, such as talc, pyrophyllite clay, silica, attapulgite clay, kaolin clay, kieselguhr, chalk, diatomaceous earth, lime, calcium carbonate, bentonite clay, Fuller's earth, cotton seed hulls, wheat flour, soybean flour, pumice, wood flour, walnut shell flour, lignin, etc. in an amount of from greater than 0% by weight to at least 50% by weight;

safeners, which provide better crop plant compatibility when applied jointly with active herbicides. Some safeners are themselves herbicidally active, and may act as an antidote to or antagonist in the crop plants and thus reduce or even prevent damage to the crop plants. Suitable exemplary safeners include AD 67 (MON 4660), benoxacor, cloquintocet-mexyl (including lithium, sodium, potassium, calcium, magnesium, aluminium, iron, ammonium, quaternary ammonium, sulfonium or phosphonium salts thereof), cyometrinil, dicyclinon, dietholate, cyprosulfamide (CAS RN 221667-31-8), oxabetrinil, dichlormid, fenchlorazole-ethyl, fenclorim, fluxofenim, furilazole, flurazole, isoxadifen-ethyl, mefenpyr-diethyl, mephenate, naphthalic acid anhydride, N-isopropyl-4-(2-methoxy-benzoylsulfamoyl)-benzamide (CAS RN 221668-34-4), N-(2-methoxybenzoyl)-4-[(methylaminocarbonyl)amino]-benzenesulfonamide, 2,2,5-trimethyl-3-(dichloracetyl)-1,3-oxazolidine, 4-(dichloroacetyl)-1-oxa-4-azaspiro[4.5]decane and oxabetrinil, agriculturally acceptable salts and derivatives thereof, and 2,2,5-Trimethyl-3-(dichloroacetyl)-1,3-oxazolidine [CAS No. 52836-31-4] (also known as R-29148. 4-(Dichloroacetyl)-1-oxa-4-azaspiro[4.5]decane). Safeners can be used in any efficacious amount, such as an amount of the active or actives to the safener of from 100:1 to 1:10; and

other adjuvants, such as compatibilizing agents, antifoaming agents, sequestering agents, neutralizing agents, buffers, corrosion inhibitors, dyes, odorants, spreading agents, penetration aids, sticking agents, dispersing agents, thickening agents, freezing point depressants, antimicrobial agents, etc.

B. Other Active Pesticides and/or Herbicides

A person of ordinary skill in the art will appreciate that presently disclosed combinations or compositions comprising Pronamide, or analogs thereof, and Imazethapyr, or analogs thereof, also can be combined with, or used in combination with, other active herbicides at any desired effective amount, such as greater than 0% by weight up to at least 50% by weight. When used in conjunction with other co-herbicides, disclosed embodiments of the present composition can be formulated with the other co-herbicide or co-herbicides, tank mixed with the other co-herbicide or co-herbicides, or applied simultaneously or sequentially in any order with the other co-herbicide or co-herbicides. Such co-herbicide or co-herbicides can include at least one additional herbicide or herbicide safener of any suitable class of herbicide, including but not limited to: acetolactate synthase inhibitors [ALS, which also may be referred to as acetohydroxy acid synthase (AHAS) inhibitors], such as triazolopyrimidine herbicides, sulfonylamino-carbonyl-triazolinone herbicides, pyrimidinyl(thio) benzoate herbicides, and imidizolinone herbicides; protoporphyrinogen oxidase inhibitors (PPO), such as pyrimidinedione herbicides, triazolinone herbicides, diphenyl ether herbicides, and N-phenyl phthalimide herbicides; synthetic auxins, such as benzoic acid herbicides, quinolinecarboxylic acid herbicides; pyridine carboxylic acid herbicides; phenoxycarboxylic acid herbicides; microtubule inhibitors, such as dinitroaniline herbicides, e.g. benfluralin, butralin, dinitramine, ethalfluralin, fluchloralin, oryzalin, pendimethalin, prodiamine and trifluralin; phosphoroamidate herbicides, such as amiprophos, amiprophos-methyl and butamiphos; pyridine herbicides, such as dithiopyr and thiazopyr; additional different benzamide herbicides, such as tebutam; and additional benzoic acid herbicides, such as chlorthal and chlorthal-dimethyl; acetyl-CoA carboxylase inhibitors, such as aryloxyphenoxy-propionate herbicides; cyclohexanedione herbicides; phenylpyrazoline herbicides; photosystem II inhibitors, such as arylurea herbicides, triazin(di)one herbicides, triazine herbicides, pyridazinone herbicides, phenylcarbamate herbicides, nitrile herbicides, benzothiadiazinone herbicides, and uracil herbicides; pigment synthesis inhibitors, such as arylurea herbicides, triazin(di)one herbicides, triazine herbicides, pyridazinone herbicides, phenylcarbamate herbicides, nitrile herbicides, benzothiadiazinone herbicides, and uracil herbicides; and VLCFA inhibitors, such as chloroacetamide herbicides, oxyacetamide herbicides, and tetrazolinone herbicides.

Particular examples of such co-herbicides include ioxynil, aclonifen, acrolein, azafenidin, acifluorfen (including salts such as sodium), azimsulfuron, asulam, acetochlor, atrazine, anilofos, amicarbazone, amidosulfuron, amitrole, aminocyclopyrachlor, aminopyralid, amiprofos-methyl, ametryn, alachlor, alloxydim, ancymidol, isouron, isoxachlortole, isoxaflutole, isoxaben, Isodecylalkoholethoxylat, isoproturon, ipfencarbazone, imazaquin, imazapic (including salts such as amine), imazapyr (including salts such as isopropylamine), imazamethabenz-methyl, imazamox, imazosulfuron, indaziflam, indanofan, eglinazine-ethyl, esprocarb, ethametsulfuron-methyl, ethalfluralin, ethidimuron, ethoxysulfuron, ethoxyfen-ethyl, ethofumesate, etobenzanid, endothal-disodium, oxadiazon, oxadiargyl, oxaziclomefone, oxasulfuron, oxyfluorfen, oryzalin, orthosulfamuron, orbencarb, oleic acid, cafenstrole, carfentrazone-ethyl, karbutilate, carbetamide, quizalofop, quizalofop-ethyl, quizalofop-P-ethyl, quizalofop-P-tefuryl, quinoclamine, quinclorac, quinmerac, cumyluron, clacyfos, glyphosate (including salts such as sodium, potassium, amine, propylamine, isopropylamine, dimethylamine or trimesium), glufosinate (including salts such as amine or sodium), glufosinate-P, glufosinate-P-sodium, clethodim, clodinafop-propargyl, clopyralid, clomazone, chlomethoxyfen, clomeprop, cloransulam-methyl, chloramben, chloridazon, chlorimuron-ethyl, chlorsulfuron, chlorthal-dimethyl, chlorthiamid, chlorphthalim, chlorflurenol-methyl, chlorpropham, chlorbromuron, chloroxuron, chlorotoluron, ketospiradox (including salts such as sodium, calcium, or ammonia), saflufenacil, sarmentine, cyanazine, cyanamide, diuron, diethatyl-ethyl, dicamba (including salts such as amine, diethylamine, isopropylamine, diglycolamine, sodium or lithium), cycloate, cycloxydim, diclosulam, cyclosulfamuron, cyclopyrimorate, dichlobenil, diclofop-P-methyl, diclofop-methyl, dichlorprop, dichlorprop-P, diquat, dithiopyr, siduron, dinitramine, cinidon-ethyl, cinosulfuron, dinoseb, dinoterb, cyhalofop-butyl, diphenamid, difenzoquat, diflufenican, diflufenzopyr, simazine, dimethachlor, dimethametryn, dimethenamid, dimethenamid-P, simetryn, dimepiperate, dimefuron, cinmethylin, swep, sulcotrione, sulfentrazone, sulfosate, sulfosulfuron, sulfometuron-methyl, sethoxydim, terbacil, daimuron, thaxtomin A, dalapon, thiazopyr, tiafenacil, thiencarbazone (including sodium salt, methyl ester or the like), tiocarbazil, thiobencarb, thidiazimin, thidiazuron, thifensulfuron-methyl, desmedipham, desmetryne, thenylchlor, tebutam, tebuthiuron, tepraloxydim, tefuryltrione, terbuthylazine, terbutryn, terbumeton, tembotrione, topramezone, tralkoxydim, triaziflam, triasulfuron, triafamone, tri-allate, trietazine, triclopyr, triclopyr-butotyl, tritosulfuron, trifludimoxazin, triflusulfuron-methyl, trifluralin, trifloxysulfuron-sodium, tribenuron-methyl, tolpyralate, naptalam (including salts such as sodium), naproanilide, napropamide, napropamide-M, nicosulfuron, neburon, norflurazon, vernolate, paraquat dichloride, halauxifen-benzyl, halauxifen-methyl, haloxyfop, haloxyfop-P, haloxyfop-etotyl, halosafen, halosulfuron-methyl, picloram, picolinafen, bicyclopyrone, bispyribac-sodium, pinoxaden, bifenox, piperophos, pyraclonil, pyrasulfotole, pyrazoxyfen, pyrazosulfuron-ethyl, pyrazolynate, bilanafos, pyraflufen-ethyl, pyridafol, pyrithiobac-sodium, pyridate, pyriftalid, pyributicarb, pyribenzoxim, pyrimisulfan, pyriminobac-methyl, pyroxasulfone, pyroxsulam, phenisopham, fenuron, fenoxasulfone, fenoxaprop (including methyl, ethyl and isopropyl ester), fenoxaprop-P (including methyl, ethyl and isopropyl ester), fenthiaprop-ethyl, fentrazamide, phenmedipham, foramsulfuron, butachlor, butafenacil, butamifos, butylate, butenachlor, butralin, butroxydim, flazasulfuron, flamprop (including methyl, ethyl and isopropyl ester), flamprop-M (including methyl, ethyl and isopropyl ester), primisulfuron-methyl, fluazifop-butyl, fluazifop-P-butyl, fluazolate, fluometuron, fluoroglycofen-ethyl, flucarbazone-sodium, fluchloralin, flucetosulfuron, fluthiacet-methyl, flupyrsulfuron-methyl (including salts such as sodium, calcium or ammonia), flufenacet, flufenpyr-ethyl, flupropanate, flupoxame, flumioxazin, flumiclorac-pentyl, flumetsulam, fluridone, flurtamone, fluroxypyr (including esters such as butomethyl and meptyl, and salts such as sodium, calcium or ammonia), flurochloridone, pretilachlor, procarbazone-sodium, prodiamine, prosulfuron, prosulfocarb, propaquizafop, propachlor, propazine, propanil, propisochlor, propyrisulfuron, propham, profluazol, prohexadione-calcium, propoxycarbazone, propoxycarbazone-sodium, profoxydim, bromacil, brompyrazon, prometryn, prometon, bromoxynil (including esters such as butyric acid, octanoic acid or heptanoic acid), bromofenoxim, bromobutide, florasulam, florpyrauxifen, florpyrauxifen-benzyl, hexazinone, pethoxamid, benazolin, penoxsulam, heptamaloxyloglucan, beflubutamid, pebulate, pelargonic acid, bencarbazone, pendimethalin, benzfendizone, bensulide, bensulfuron-methyl, benzobicyclon, benzofenap, bentazone, pentanochlor, pentoxazone, benfluralin, benfuresate, fosamine, fomesafen, foramsulfuron, forchlorfenuron, mecoprop (including salts such as sodium, potassium, isopropylamine, triethanolamine or dimethylamine), mecoprop-P-potassium, mesosulfuron (including esters such as methyl), mesotrione, metazachlor, metazosulfuron, methabenzthiazuron, metamitron, metamifop, metam, DSMA, methiozolin, methyldymuron, metoxuron, metosulam, metsulfuron-methyl, metobromuron, metobenzuron, metolachlor, metribuzin, mepiquat chloride, mefenacet, monosulfuron (including methyl, ethyl and isopropyl ester), monolinuron, molinate, iodosulfuron, iodosulfulon-methyl-sodium, iofensulfuron, iofensulfuron-sodium, lactofen, lancotrione, linuron, rimsulfuron, lenacil, TCA (including salts such as sodium, calcium or ammonia), 2,3,6-TBA, 2,4,5-T, 2,4-D (including salts such as amine, diethylamine, triethanolamine, isopropylamine, sodium or lithium), ACN, AE-F-150944 (Code number), MCPA, MCPB (including sodium salt, ethyl ester or the like), 2,4-DB, DNOC (including salts such as amine or sodium), MCPA-thioethyl, IR-6396 (Code number), SYP-298 (Code number), SYP-300 (Code number), EPTC, S-metolachlor, S-9750 (Code number), MSMA, and HW-02 (Code number), as well as salts and analogues of these compounds; 2,3,6-TBA, 2,3,6-TBA-dimethylammonium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropyl ammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecyl ammonium, 2,4-D-triethylammonium, 2,4-D-tris(2-hydroxypropyl)ammonium, 2,4-D-trolamine, 3,4-DA, 3,4-DB, 3,4-DP, 4-CPA, 4-CPB, 4-CPP, acetochlor, acifluorfen, acifluorfen-methyl, acifluorfen-sodium, aclonifen, acrolein, alachlor, allidochlor, alloxydim, alloxydim-sodium, allyl alcohol, alorac, ametridione, ametryn, amibuzin, amicarbazone, amidosulfuron, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amitrole, ammonium sulfamate, anilofos, anisuron, asulam, asulam-potassium, asulam-sodium, atraton, atrazine, azafenidin, azimsulfuron, aziprotryne, barban, BCPC, beflubutamid, benazolin, benazolin-dimethylammonium, benazolin-ethyl, benazolin-potassium, bencarbazone, benfluralin, benfuresate, bensulfuron, bensulfuron-methyl, bensulide, bentazone, bentazone-sodium, benzadox, benzadox-ammonium, benzfendizone, benzipram, benzobicyclon, benzofenap, benzofluor, benzoylprop, benzoylprop-ethyl, benzthiazuron, bicyclopyrone, bifenox, bilanafos, bilanafos-sodium, bispyribac, bispyribac-sodium, borax, bromacil, bromacil-lithium, bromacil-sodium, bromobonil, bromobutide, bromofenoxim, bromoxynil, bromoxynil butyrate, bromoxynil heptanoate, bromoxynil octanoate, bromoxynil-potassium, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, carfentrazone, carfentrazone-ethyl, CDEA, CEPC, chlomethoxyfen, chloramben, chloramben-ammonium, chloramben-diolamine, chloramben-methyl, chloramben-methylammonium, chloramben-sodium, chloranocryl, chlorazifop, chlorazifop-propargyl, chlorazine, chlorbromuron, chlorbufam, chloreturon, chlorfenac, chlorfenac-sodium, chlorfenprop, chlorfenprop-methyl, chlorflurazole, chlorflurenol, chlorflurenol-methyl, chloridazon, chlorimuron, chlorimuron-ethyl, chlornitrofen, chloropon, chlorotoluron, chloroxuron, chloroxynil, chlorprocarb, chlorpropham, chlorsulfuron, chlorthal, chlorthal-dimethyl, chlorthal-monomethyl, chlorthiamid, cinidon-ethyl, cinmethylin, cinosulfuron, cisanilide, clethodim, cliodinate, clodinafop, clodinafop-propargyl, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloransulam, cloransulam-methyl, CMA, copper sulfate, CPMF, CPPC, credazine, cresol, cumyluron, cyanamide, cyanatryn, cyanazine, cycloate, cyclosulfamuron, cycloxydim, cycluron, cyhalofop, cyhalofop-butyl, cyperquat, cyperquat chloride, cyprazine, cyprazole, cypromid, daimuron, dalapon, dalapon-calcium, dalapon-magnesium, dalapon-sodium, dazomet, dazomet-sodium, delachlor, desmedipham, desmetryn, di-allate, dicamba, dicamba-dimethylammonium, dicamba-diolamine, dicamba-isopropylammonium, dicamba-methyl, dicamba-olamine, dicamba-potassium, dicamba-sodium, dicamba-trolamine, dichlobenil, dichloralurea, dichlormate, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-dimethylammonium, dichlorprop-potassium, dichlorprop-sodium, diclofop, diclofop-methyl, diclosulam, diethamquat, diethamquat dichloride, diethatyl, diethatyl-ethyl, difenopenten, difenopenten-ethyl, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimexano, dimidazon, dinitramine, dinofenate, dinoprop, dinosam, dinoseb, dinoseb acetate, dinoseb-ammonium, dinoseb-diolamine, dinoseb-sodium, dinoseb-trolamine, dinoterb, dinoterb acetate, diphacinone-sodium, diphenamid, dipropetryn, diquat, diquat dibromide, disul, disul-sodium, dithiopyr, diuron, DMPA, DNOC, DNOC-ammonium, DNOC-potassium, DNOC-sodium, DSMA, EBEP, eglinazine, eglinazine-ethyl, endothal, endothal-diammonium, endothal-dipotassium, endothal-disodium, epronaz, EPTC, erbon, esprocarb, ethalfluralin, ethametsulfuron, ethametsulfuron-methyl, ethidimuron, ethiolate, ethofumesate, ethoxyfen, ethoxyfen-ethyl, ethoxysulfuron, etinofen, etnipromid, etobenzanid, EXD, fenasulam, fenoprop, fenoprop-3-butoxypropyl, fenoprop-butometyl, fenoprop-butotyl, fenoprop-butyl, fenoprop-isoctyl, fenoprop-methyl, fenoprop-potassium, fenoxaprop, fenoxaprop-ethyl, fenoxaprop-P, fenoxaprop-P-ethyl, fenoxasulfone, fenteracol, fenthiaprop, fenthiaprop-ethyl, fentrazamide, fenuron, fenuron TCA, ferrous sulfate, flamprop, flamprop-isopropyl, flamprop-M, flamprop-methyl, flamprop-M-isopropyl, flamprop-M-methyl, flazasulfuron, florasulam, fluazifop, fluazifop-butyl, fluazifop-methyl, fluazifop-P, fluazifop-P-butyl, fluazolate, flucarbazone, flucarbazone-sodium, flucetosulfuron, fluchloralin, flufenacet, flufenican, flufenpyr, flufenpyr-ethyl, flumetsulam, flumezin, flumiclorac, flumiclorac-pentyl, flumioxazin, flumipropyn, fluometuron, fluorodifen, fluoroglycofen, fluoroglycofen-ethyl, fluoromidine, fluoronitrofen, fluothiuron, flupoxam, flupropacil, flupropanate, flupropanate-sodium, flupyrsulfuron, flupyrsulfuron-methyl-sodium, fluridone, flurochloridone, fluroxypyr, fluroxypyr-butometyl, fluroxypyr-meptyl, flurtamone, fluthiacet, fluthiacet-methyl, fomesafen, fomesafen-sodium, foramsulfuron, fosamine, fosamine-ammonium, furyloxyfen, glufosinate, glufosinate-ammonium, glufosinate-P, glufosinate-P-ammonium, glufosinate-P-sodium, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, hexachloroacetone, hexaflurate, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, indanofan, indaziflam, iodobonil, iodomethane, iodosulfuron, iodosulfuron-methyl-sodium, ioxynil, ioxynil octanoate, ioxynil-lithium, ioxynil-sodium, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-dimethylammonium, mecoprop-P-isobutyl, mecoprop-potassium, mecoprop-P-potassium, mecoprop-sodium, mecoprop-trolamine, medinoterb, medinoterb acetate, mefenacet, mefluidide, mefluidide-diolamine, mefluidide-potassium, mesoprazine, mesosulfuron, mesosulfuron-methyl, mesotrione, metam, metam-ammonium, metamifop, metamitron, metam-potassium, metam-sodium, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metolachlor, metosulam, metoxuron, metribuzin, metsulfuron, metsulfuron-methyl, molinate, monalide, monisouron, monochloroacetic acid, monolinuron, monuron, monuron TCA, morfamquat, morfamquat dichloride, MSMA, naproanilide, napropamide, naptalam, naptalam-sodium, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxapyrazon-dimolamine, oxapyrazon-sodium, oxasulfuron, oxaziclomefone, oxyfluorfen, parafluron, paraquat, paraquat dichloride, paraquat dimetilsulfate, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, pinoxaden, piperophos, potassium arsenite, potassium azide, potassium cyanate, pretilachlor, primisulfuron, primisulfuron-methyl, procyazine, prodiamine, profluazol, profluralin, profoxydim, proglinazine, proglinazine-ethyl, prometon, prometryn, propachlor, propanil, propaquizafop, propazine, propham, propisochlor, propoxycarbazone, propoxycarbazone-sodium, propyrisulfuron, prosulfalin, prosulfocarb, prosulfuron, proxan, proxan-sodium, prynachlor, pydanon, pyraclonil, pyraflufen, pyraflufen-ethyl, pyrasulfotole, pyrazolynate, pyrazosulfuron, pyrazosulfuron-ethyl, pyrazoxyfen, pyribenzoxim, pyributicarb, pyriclor, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quinonamid, quizalofop, quizalofop-ethyl, quizalofop-P, quizalofop-P-ethyl, quizalofop-P-tefuryl, rhodethanil, rimsulfuron, saflufenacil, sebuthylazine, secbumeton, sethoxydim, siduron, simazine, simeton, simetryn, SMA, S-metolachlor, sodium arsenite, sodium azide, sodium chlorate, sulcotrione, sulfallate, sulfentrazone, sulfometuron, sulfometuron-methyl, sulfosulfuron, sulfuric acid, sulglycapin, swep, TCA, TCA-ammonium, TCA-calcium, TCA-ethadyl, TCA-magnesium, TCA-sodium, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone, thiencarbazone-methyl, thifensulfuron, thifensulfuron-methyl, thiobencarb, tiocarbazil, tioclorim, topramezone, tralkoxydim, tri-allate, triasulfuron, triaziflam, tribenuron, tribenuron-methyl, tricamba, triclopyr, triclopyr-butotyl, triclopyr-ethyl, triclopyr-triethylammonium, tridiphane, trietazine, trifloxysulfuron, trifloxysulfuron-sodium, trifluralin, triflusulfuron, triflusulfuron-methyl, trifop, trifop-methyl, trifopsime, trihydroxytriazine, trimeturon, tripropindan, tritac, tritosulfuron, vernolate, or xylachlor; and wherein the herbicide safener is selected from benoxacor, cloquintocet-mexyl, cyprosulfamide, dichlormid, fenchlorazole-ethyl, fenclorim, fluxofenim, furilazole and the corresponding R isomer, isoxadifen-ethyl, mefenpyr-diethyl, oxabetrinil, N-isopropyl-4-(2-methoxy-benzoylsulfamoyl)-benzamide, and N-(2-methoxybenzoyl)-4-[(methylaminocarbonyl)amino]benzenesulfonamide.

Certain disclosed embodiments concern using a combination of, or a composition comprising, a benzamide herbicide and a pyridine carboxylic acid herbicide with one or more co-herbicides selected from: 2,4-D, acetochlor, metolachlor, metolachlor S, azoxystrobin, azoxystrobin plus metalaxyl, azoxystrobin plus propiconazole, bromoxynil, carfentrazone, clopyralid, flucarbazone, flumetsulam, fluroxypyr, fluroxypyr plus clopyralid, imazamox, imazethapyr, imazamox plus imazethapyr, imidacloprid, cyhalothrin, lamba-cyhalothrin, MCPA, prothioconazole, tebuconazole, metalaxyl, metalaxyl plus tebuconazole and prothioconazole, pinoxaden, pinoxaden plus cloquintocet, propiconazole, pyraclostrobin, pyroxasulfone, quinclorac, atrazine, acetochlor plus atrazine, trifloxystrobin, prothioconazole plus trifloxystrobin, metconazole, boscalid, mesotrione, atrazine plus mesotrione plus metolachlor S, bentazon, bentazon plus imazamox, boscalid plus prothioconazole, flucarbazone, metconazole-pyraclostrobin, metolachlor-s-metribuzin, saflufenacil, atrazine-metolachlor-s, fluroxypyr-2,4-d, flumioxazin, metconazole+pyraclostrobin 58.69%, fluroxypyr-florasulam-mcpa, prothioconazole-trifloxystrobin, pendimethalin, fluroxypyr-clopyralid-mcpa ester, fomesafen-metolachlor-s, prothioconazole-tebuconazole, quizalofop, ethalfluralin, fomesafen-glyphosate, tembotrione, tribenuron, isoxaflutole, thifensulfuron-tribenuron, bromoxynil-mcpa ester, topramezone, ethephon, fenoxaprop-p, pyroxsulam, prothioconazole+tebuconazole+metalaxyl, sulfentrazone, pyraclostrobin, thiencarbazone, bromoxynil-pyrasulfotole-thiencarbazone-methyl, pyrasulfotole-fenoxaprop-p-bromoxynil, bromoxynil-pyrasulfatole, bromoxynil-pyrasulfotole, pyrasulfotole-thiencarbazone-bromoxynil, tembotrione-thiencarbazone-methyl, isoxaflutole-thiencarbazone-methyl, and abamectin.

Compositions of the present invention are particularly suitable for use in combination with: Glyphosate (N-(phosphonomethyl)glycine, typically used at an application rate of 0.5 pounds per acre to 1.50 pounds per acre); Pendimethalin (3,4-Dimethyl-2,6-dinitro-N-pentan-3-yl-aniline, typically used at an application rate of 1.8 pounds per acre to 4.4 pounds per acre); or any alfalfa products for pre- or post-application, such as Buctril (5-dibromo-4-hydroxybenzonitrile, typically used at an application rate of about 0.6 pounds grams per 2.5 acres); 2,4-DB (4-(2,4-dichlorophenoxy)butanoic acid typically used at an application rate of about 3 pounds per acre); POAST (sethoxydim active agent, (2-[1-(ethoxyimino)butyl]-5-[2-(ethylthio)propyl]-3-hydroxy-2-cyclohexen-1-one, with a typical application rate of 2.5 pounds per acre); POAST PLUS (sethoxydim); Prism (rimsulfuron, (1-(4,6-dimethoxypyrimidin-2-yl)-3-(3-ethylsulfonyl-2-pyridylsulfonyl)urea, typically used at an application rate of about 2.0 ounces per acre or less); and Select (clethodim, (2-[(Z)—N-[(E)-3-chloroprop-2-enoxy]-C-ethylcarbonimidoyl]-5-(2-ethylsulfanylpropyl)-3-hydroxycyclohex-2-en-1-one, with a typical application rate of about 12 to 16 ounces per acre).

C. Formulation Types

Disclosed compositions can be formulated in a number of different ways, as will be understood by a person of ordinary skill in the art. See, for example, Manual on Development and Use of FAO Specifications for Plant Protection Products. Suitable formulations may depend on the exact active ingredient(s) used in the formulation, other components of such compositions, and/or the manner in which disclosed compositions are to intended to be used to control unwanted vegetation. Exemplary formulations include:

dustable powders (DP), which can be prepared by mixing active compounds with one or more solid diluents (e.g. clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) followed by mechanically grinding the mixture to a fine powder;

soluble powders (SP) and water-soluble granules (SG), which can be prepared by mixing active compounds with one or more water-soluble inorganic salts (such as sodium bicarbonate, sodium carbonate or magnesium sulphate) a water-soluble organic solid (such as a polysaccharide) to form a mixture that is then ground to a fine powder;

water dispersible granules (WDG) and wettable powders (WP), which can be prepared by mixing active compounds with solid diluents or carriers, a wetting agent, a dispersing agent and/or a suspending agent, and grinding the mixture to a fine powder;

granules (GR) (slow or fast release), which can be formed either by granulating a mixture of actives, potentially in combination with a powdered solid diluent or carrier, or by absorbing active compounds (or a solution or suspension thereof in a suitable agent) in or onto a porous granular material (such as pumice, attapulgite clays, fuller's earth, kieselguhr, or diatomaceous earth), or a core material (such as sand, silicates, mineral carbonates, sulphates or phosphates). Formulation additives also may be included in granules (for example as an emulsifying agent, wetting agent or dispersing agent);

soluble concentrates (SL);

oil miscible liquids (OL);

ultra low volume liquids (UL);

emulsifiable concentrates (EC) or oil-in-water emulsions (EW), which can be prepared by dissolving an active compound or compounds in a suitable organic solvent (such as alkylbenzenes or alkylnaphthalenes), ketones (such as cyclohexanone or methylcyclohexanone), alcohols (such as benzyl alcohol, furfuryl alcohol or butanol), N-alkylpyrrolidones (such as N-methylpyrrolidone or N-octylpyrrolidone), dimethyl amides of fatty acids (such as C.sub.8-C.sub.10 fatty acid dimethylamide) and chlorinated hydrocarbons. An EC product may spontaneously emulsify on addition to water, to produce an emulsion with sufficient stability to allow spray application using appropriate equipment;

dispersible concentrates (DC), which can be prepared by dissolving one or more active compounds in water or an organic solvent, such as a ketone, alcohol or glycol ether;

emulsions [including oil in water (EW) and water in oil (EO) emulsions], which can be prepared by using one or more actives either as a liquid or in solution, and then emulsifying the resultant liquid or solution into water, potentially containing one or more surface active agents. Suitable solvents include vegetable oils, chlorinated hydrocarbons (such as chlorobenzenes), and aromatic solvents (such as alkylbenzenes or alkylnaphthalenes);

micro-emulsions (ME), which may be prepared by mixing water with a solvent or solvents, optionally with one or more surface active agents. An active compound or compounds is present initially in either the water or the solvent as described above for ECs or in EWs. A ME may be either an oil-in-water or a water-in-oil system, which can be determined using conductivity measurements).

suspension concentrates (SC), which comprise aqueous or non-aqueous suspensions of finely divided, insoluble solid particles of an active compound or compounds and may be prepared by ball or bead milling a solid active compound or compounds in a suitable medium to produce a fine particle suspension of the compound. One or more wetting agents and/or a suspending agent may be included to reduce particle settlement rate. An active compound or compounds also may be dry milled and added to water, optionally with other formulation agents, to produce the desired end product; and

aerosols, which comprise an active compound or compounds and a suitable propellant (for example a lower alkane, such as n-butane). An active compound or compounds also may be dissolved or dispersed in water or a water-miscible liquid, such as an alkyl alcohol, such as propanol, for use in spray pumps.

### VI. Method of Use

Disclosed embodiments concern using a combination or composition for controlling undesirable vegetation in crops. Disclosed method embodiments may comprise applying an herbicidal combination or composition according to the present invention to a locus of planted crops where undesirable vegetation occurs or might occur or to a locus where crops will be planted before planting or emergence of the crop. Application can be done before, during and/or after, preferably during and/or after, the emergence of the undesirable vegetation. The benzamide herbicide, the pyridine carboxylic acid, and any optional third or more co-herbicide, can be applied simultaneously, including as a premix or a tank mix, or in succession. The invention in particular relates to a method for controlling undesirable vegetation in crops comprising applying a disclosed composition comprising Pronamide and Imazethapyr to a locus of planted crops where undesirable vegetation occurs or might occur or to a locus where crops will be planted before planting or emergence of the crop. The combination or composition also can be applied to a locus of planted crops which, by genetic engineering or by breeding, are resistant to one or more herbicides and/or pathogens such as plant-pathogenous fungi, and/or to attack by insects. Although certain exemplary embodiments are formulated as a premix comprising a benzamide herbicide and a pyridine carboxylic acid herbicide, a person of ordinary skill in the art will appreciate that the benzamide herbicide, the pyridine carboxylic acid herbicide, and the one or more optional co-herbicides, may be formulated jointly or separately and applied jointly or separately. Moreover, in the case of separate application, the order of application also may vary. However, when used as a combination, the benzamide herbicide and the pyridine carboxylic acid herbicide should be applied in a time frame that allows simultaneous action of the active ingredients on the undesirable plants.

Disclosed herbicidal compositions of the present application can be applied in any manner suitable as will be known to a person of ordinary skill in the art. For example, disclosed herbicidal compositions can be surface applied prior to planting, such as 45 days prior to planting.

Disclosed herbicidal compositions also can be preplant incorporated into soil after it is prepared for planting. Disclosed herbicidal compositions are incorporated to an effective soil depth, such as a depth of 1 to 2 inches. Herbicidal compositions can be used after crops are planted, such as by using a rolling cultivator.

Disclosed herbicidal compositions also can be used as a post emergence treatment when crops and weeds are actively growing and preferably before weeds are more than 3-inches tall. It can be beneficial to delay application of disclosed herbicidal compositions until the majority of weeds are at a specified growth stage. The timing of application preferably may be based on weed size as opposed to crop growth stage.

Furthermore, compositions according to the present invention can be applied in any manner, and for the same purposes, as are already known for Imazethapyr and Pronamide. Imazethapyr, for example, is a selective herbicide that can be applied to soil as an early pre-plant, pre-plant incorporated, pre-emergent or post-emergent treatment in various crops. The application method may depend upon the crop, anticipated weed spectrum and the preference of the applicator. For early pre-plant and pre-emergent treatments, susceptible weeds emerge, are present as stunted plants, and then die. When Imazethapyr herbicide is applied post-emergence, absorption may occur through both the roots and foliage. Susceptible weeds stop growing and eventually die. Imazethapyr is advantageously applied at 75 g active-100 g active per hectare.

Compositions comprising Imazethapyr, including compositions according to the present application, can be used with any of a number of crops, including but not limited to, the following registered crops: adzuki beans, alfalfa, such as is grown for seed production, dry common beans of the species Phaseolus vulgaris, Imazethapyr tolerant corn (e.g. CLEARFIELD Brands), lima beans (Ontario only), processing peas, snap beans, snow peas, and soybeans.

Pronamide is a selective, systemic, pre- and post-emergence herbicide that is used to control, for example and without limitation, grasses and broadleaf weeds in food and feed crops including lettuce (the largest use site), endive, alfalfa, rhubarb, pome and stone fruits, artichokes, berries, grapes and legumes, as well as on woody ornamentals, Christmas trees, nursery stock, lawns, turf and fallow land. Pronamide formulations, and hence compositions according to the present invention, may be formulated as a wettable powder or a granular formulation, that may be applied using ground spray equipment, by soil incorporation, and/or by aircraft.

Disclosed herbicidal combinations and compositions can be used to control a number of weeds, such as broadleaf weeds, grass weeds and sedges. Exemplary broadleaf weeds include Artichoke, Jerusalem, Bedstraw, Catchweed, Beet, Buckwheat, Chickweed, Cocklebur, Hoary Cress, Dandelion, Dock, Dodder, Fiddleneck, Filaree, Fleabane, Fixweed, Goosefoot, Grounsel, Henbit, Jimsonweed, Knotweed, Kochia, Lambsquarters, Lettuce, Mallow, Marshelder, Morningglory, Mustgarfd, Nettle, Nightshade, Oxtongue, Pennycress, Pepperweed, Pigweed, Radish, Ragweed, Redmaids, Rocket, Rockpurslane, Shepperd's Purse, Smartweed, Spurge, Spurry, Sunflower, Swinecress, Tansymustard, Thistle, Velvetleaf, Watercress, and Willoweed.

Exemplary grass weeds and sedges include Barnyard Grass, Bluegrass, Canarygrass, Cereals such as Barley, Oat and Wheat, Crabgrass, Cupgrass, Foxtail, Johnson Grass, Millet, Nutsedge, Quackgrass, Rice, Shattercrane and Signalgrass.

Rates of application for combinations and formulations according to the present invention may vary and depend on a variety of factors, including the soil type, the method of application (e.g. pre- or post-emergence), the crop plant, the weed(s) to be controlled, prevailing climate, the time of application and the target crop. Combinations and formulations according to the present invention are generally applied at a rate of from less than 50 fluid ounces per acre, such as from 20 to 40 fluid ounces per acre, and more typically 30 to 40 or 30 to 35 fluid ounces per acre, particularly when applied as a premix concentrate comprising 33%-35% Pronamide and 17-18% Imazethapyr.

### VII. Examples

The following examples are provided to exemplify certain features of the presently disclosed embodiments. A person of ordinary skill in the art will appreciate that the scope of the invention is not limited to these specific features.

### Example 1

This example concerns one embodiment of a composition according to the present invention and a method for making the composition.

TABLE 1
Finished Product Formula

| MATERIAL | Wt. % |
|---|---|
| Water | 28.43 |
| Aciticide LA1206 | 0.16 |
| [mixture of -bromo-2-nitropropane-1, | |
| 3-diol (8.80%), 5-chloro-2-methyl-4- | |
| isothiazolin-3-one (0.85%) and 2- | |
| methyl-4-isothiazolin-3-one | |
| (0.28%)]. | |
| AU-760B | 25.0 |
| SAG 1572 | 0.10 |
| [polydimethylsiloxane emulsion] | |
| Pronamide | 33.33 |
| (Propyzamide) technical (97.5%) | |
| Imazethapyr (99.74%) | 1.73 |
| Gel Base | 11.25 |
| Total | 100.0 |

TABLE 2
Gel Base Formula

| MATERIAL | Wt. % |
|---|---|
| Water | 88.37 |
| Aciticide LA1206 | 0.19 |
| Hexylene Glycol | 9.0 |
| Xanthan Gum | 2.44 |
| Total | 100.0 |

TABLE 3
CSF Formula

| MATERIAL | Wt. % |
|---|---|
| Water | 38.37 |
| Hexylene Glycol | 1.01 |
| Xanthan Gum | 0.27 |
| Aciticide LA1206 | 0.19 |
| AU-760B | 25.0 |
| SAG 1572 | 0.10 |
| Pronamide | 33.33 |
| (Propyzamide) technical (97.5%) | |
| Imazethapyr technical (99.74%) | 1.73 |
| Total | 100.0 |

Finished Product Mixing Instructions. Add 95% of the required water and the full amounts of the AU-760B, SAG 1572, Pronamide (propyzamide) technical and imazethapyr technical in the above order to a vessel with agitation until thoroughly mixed. The mixture is circulated through a media mill until the batch meets the desired particle size (dv50<3.3 microns and dv90<12 microns). The milled product is transferred to an adjustment tank through a 50-mesh screen. The required amount of the gel base is then added to meet the viscosity specification. The blend is tested for the remaining quality specifications and then is set aside to blend into a finished formula. The remaining water is added to meet the assay specification.

Gel Base Mixing Instructions. Water and Acticide LA1206 are added to a mixing vessel. Form a premix slurry comprising the hexylene glycol and xanthan gum, and add the premix slurry to the mixing vessel. Mix for 30 minutes to allow time for the xanthan gum to hydrate and to form a thick homogenous mixture, with no visible lumps or clumps. Set aside gel base to blend into the finished product.

Product Specifications: Pronamide (propyzamide) assay as specified by CSF, used at a target amount in this embodiment of 32.5%, with an acceptable range of from 31.53%-33.47%. Imazethapyr Assay as specified by CSF, used at a target amount of 1.73% in this embodiment, with an acceptable range from 1.64 to 1.81%. The target particle size of the SC Portion, μ D50, is 3 microns, with a preferred maximum particle size is 5 microns. The maximum target particle size of the SC Portion, μ D90, is 15 microns. The target specific gravity of this embodiment at 20° C. is 1.09-1.11. The target pH for this embodiment is 4.0, and the acceptable range is generally from about 3.4 to about 5.4. The target viscosity, determined using LV #2 spindle, 12 rpm, for this embodiment is 1,125 cps, and the acceptable range is 900-1300 cps. The target suspensibility tested at 3% dilution in 34, 342, 1000 ppm water, is 1 mL maximum bottom sediment in all waters after two hours.

### Example 2

This example concerns field trials conducted using embodiments of a composition according to the present invention. For these field trials, a composition comprising Pronamide and Imazethapyr was prepared. In particular, a composition was formulated comprising 32 fluid ounces of Pronamide 3.3 Sc and 2.78 fluid ounces of WW Imazethapyr 2SL. Table 4 below provides the single-application treatment protocol for the field trials.

TABLE 4

| # | TREATMENT* | USE RATE PER ACRE |
|---|---|---|
| 1 | Control (weedy plot) | |
| 2 | Pursuit/WW Imazethapyr 2SL | 4.0 fluid ounces |
| 3 | Pronamide 3.3 Sc | 32 fluid ounces |
| 4 | Pronamide 3.3 SC + | 32 fluid ounces + 2.7 to 3 |
| | Imazethapyr 2SL | fluid ounces |
| 5 | WW2019-1 | 30 fluid ounces |
| 6 | WW2019-1 | 34 to 40 fluid ounces |
| 7 | Raptor | 4 fluid ounces |

1. Trt #5: WW2019-1 is a premix of one embodiment of a formulation according to the present disclosure used at a lower application rate.

2. Trt #6: WW2019-1 is a premix of one embodiment of a formulation used at the potential recommended rate which contains full rate 32 fluid ounces of Pronamide 3.3 SC and 2.77 fluid ounces, which is a reduced rate of Pursuit as compared to full rate of 4 fluid ounces.

3. Trt #4: is tank mix version of Trt #6 to determine the benefit of formulated product.

4. Max use rate of Pursuit is up to 6 fluid ounces per year and 4 fluid ounces per application, and that of Pronamide 3.3 SC is 5 pints (80 fluid ounces) per year and 2.0 pints (32 fluid ounces) per application.

### Example 3

### WW2018-1 and Imazethapyr Premix to Control Weeds in Seedling Alfalfa

The objective of this study was to evaluate the performance of PRONAMIDE and IMAZETHAPYR in commercial alfalfa hay production in Brawley, Calif. Trial treatments applied were as follows:

TABLE 5

| # | Treatment* | Use Rate Per Acre |
|---|---|---|
| 1 | Control (weedy plot) | |
| 2 | PRONAMIDE | 2.5 pts (40 fl oz) |
| 3 | IMAZETHAPYR | 3 fl oz |
| 4 | PRONAMIDE + | 34.41 + 3fl oz (40 fl oz of |
| | IMAZETHAPYR | premix) |
| 5 | Raptor | 4 fl oz |

*All the treatments were applied with a non-ionic surfactant at 0.25 v/v and AMS at 8.5 lbs per 100 gals in the tank. The study design was a randomized complete block with 4 replicates. Each replicate consisted of 20 ft long by 14 ft wide plots (four 3.5 ft beds). Soils in the study plots are Imperial silty clay.

Treatments were applied on seedling alfalfa on March 14^{th} at second to third trifoliate stage (3-4 inches tall). Treatment applications were made using a research CO₂ backpack sprayer calibrated to deliver 50 gallons of solution per acre operating at 30 PSI. Weeds on the plots were on average 2-3 inches tall. Weather conditions during application were 34.3% RH, air and soil temperatures were 68° F. and 56.3° F. respectively, and soil moisture was dry.

No phytotoxicity effects were observed in any of the treatments. Trial was rated at 6, 13, 20, 27 and 34 days after product application (DAA). On each rating date, Percent phytotoxicity and weed control based on a 0 to 100% visual scale, and weed density (number of weeds counted on 3 square yard quadrats) per plot were conducted.

Data was checked for normality assumptions and analyzed using a univariate Analysis of Variance, and the Least Significant Difference (LSD) mean separation test at a significance level of (α=0.1). Significant differences (p<0.1) were found for the dependent variables assessed at all rating dates (See ANOVA tables). Overall, treatments 5 (Raptor 4), 4 (PRONAMIDE and IMAZETHAPYR) and treatment 3 (WW2019-2) consistently provided the best control (higher % control and lower weed densities). Treatment efficacy as evidenced by % burndown (percent control was higher than 70% in all treatments 3-5) and weed counts (remained steady or declined up to this rating date) peaked at 27 DAA and subsequently declined (weed counts increased and percent control declined) at 34 DAA.

Overall, Treatments 5, followed closely by treatments 4 and 3 performed best and provided good weed control. Although better than the untreated, Treatment 2 had less beneficial weed control.

TABLE 6
Analysis of Variance Means Table for Percent Weed Control (Burndown)

| Trt | Treatment/Rating period | | | | | | | | | | |
|---|---|---|---|---|---|---|---|---|---|---|---|
| No. | Name | 6 | DA-A | 13 | DA-A | 20 | DA-A | 27 | DA-A | 34 | DA-A |
| 1 | Control | 18 | b | 11 | c | 13 | c | 15 | b | 10 | c |
| 2 | PRONAMIDE | 15 | b | 20 | c | 38 | b | 25 | b | 8 | c |
| 3 | IMAZETHAPYR | 28 | a | 33 | b | 75 | a | 79 | a | 38 | b |
| 4 | PRONAMIDE + IMAZETHAPYR | 30 | a | 35 | ab | 80 | a | 85 | a | 48 | b |
| 5 | Raptor | 30 | a | 43 | a | 84 | a | 91 | a | 65 | a |

| | | | | | |
|---|---|---|---|---|---|
| LSD P = .10 | 9.8 | 8.9 | 21.4 | 23.7 | 11.9 |
| Standard Deviation | 7.8 | 7 | 16.5 | 18.8 | 9.4 |
| CV | 32.5 | 24.93 | 32.28 | 31.89 | 28.19 |
| Grand Mean | 24 | 28.3 | 51.3 | 59 | 33.5 |
| Levene's F | 2.25 | 0.811 | 0.421 | 0.855 | 1.38 |
| Levene's Prob (F) | 0.112 | 0.538 | 0.741 | 0.513 | 0.288 |
| Friedman's X2 | 7.95 | 12.2 | 10.2 | 14 | 13.95 |
| P (Friedman's X2) | 0.093 | 0.016 | 0.017 | 0.007 | 0.007 |
| Skewness | 0.3207 | −0.0623 | −0.8218 | −0.793 | 0.1053 |
| Kurtosis | −0.5766 | −1.5015 | −0.9651 | −1.1131 | −1.0037 |
| Replicate F | 0.658 | 5.874 | 1.69 | 1.026 | 1.701 |
| Replicate Prob (F) | 0.5937 | 0.0105 | 0.2379 | 0.4154 | 0.2197 |
| Treatment F | 3.411 | 12.58 | 15.015 | 14.686 | 27.28 |
| Treatment Prob (F) | 0.044 | 0.0003 | 0.0008 | 0.0001 | 0.0001 |

*Means followed by same letter or symbol do not significantly differ (P = .10, LSD).

TABLE 7
Analysis of Variance Means Table For Weed Density (Weeds per yd²)

| Trt | Treatment/Period | | | | | | | | | | |
|---|---|---|---|---|---|---|---|---|---|---|---|
| No. | Name | 6 | DA-A | 13 | DA-A | 20 | DA-A | 27 | DA-A | 34 | DA-A |
| 1 | Control | 41 | — | 55 | a | 48 | a | 51 | a | 80 | a |
| 2 | PRONAMIDE | 51 | — | 41 | b | 42 | ab | 43 | ab | 81 | a |
| 3 | IMAZETHAPYR | 35 | — | 25 | c | 29 | bc | 24 | cd | 39 | b |
| 4 | PRONAMIDE + IMAZETHAPYR | 33 | — | 29 | bc | 32 | bc | 33 | bc | 28 | b |
| 5 | Raptor | 40 | — | 22 | c | 26 | c | 16 | d | 24 | b |

| | | | | | |
|---|---|---|---|---|---|
| LS P = .10 | 16.6 | 12.3 | 14 | 12.9 | 19.2 |
| Standard Deviation | 13.1 | 9.7 | 11.1 | 10.2 | 15.2 |
| CV | 32.75 | 28.36 | 31.51 | 30.76 | 30.25 |
| Grand Mean | 40.1 | 34.3 | 35.2 | 33.3 | 50.2 |
| Levene's F | 1.555 | 0.193 | 0.13 | 0.543 | 0.134 |
| Levene's Prob (F) | 0.237 | 0.938 | 0.969 | 0.707 | 0.967 |
| Friedman's X2 | 4 | 11.8 | 5.6 | 13.8 | 13.6 |
| P (Friedman's X2) | 0.406 | 0.019 | 0.231 | 0.008 | 0.009 |
| Skewness | −0.2484 | 0.1717 | 0.1001 | −0.0886 | 0.3182 |
| Kurtosis | −1.0963 | −1.2063 | −1.6189 | −1.6839 | −1.3717 |
| Replicate F | 4.023 | 1.348 | 4.639 | 8.528 | 2.464 |
| Replicate Prob (F) | 0.034 | 0.3052 | 0.0224 | 0.0026 | 0.1125 |
| Treatment F | 1.144 | 8.163 | 2.875 | 7.618 | 13.563 |
| Treatment Prob (F) | 0.3822 | 0.002 | 0.0698 | 0.0027 | 0.0002 |

*Means followed by same letter or symbol do not significantly differ (P = .10, LSD).

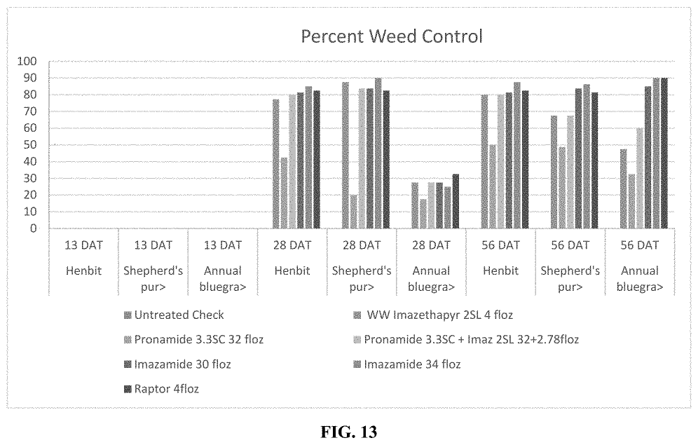

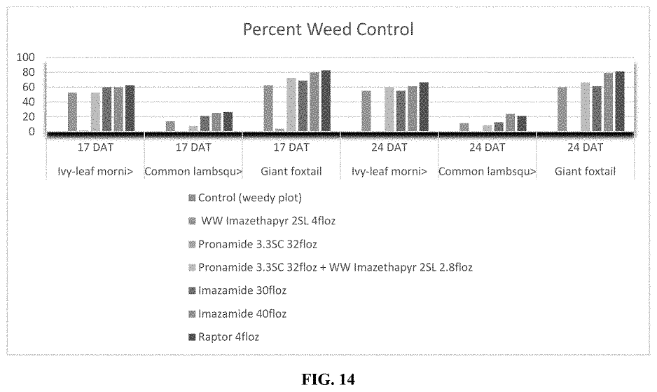

Field trials using compositions according to the present invention have established that such compositions provide good control of undesired weeds, such as Henbit, annual bluegrass, Shepherd's Purse, Ivy-leaf Morning Glory, Common Lambsquarter and Giant Foxtail, and further that no discernible signs of alfalfa injury due to the herbicide treatments were observed throughout trial periods. FIGS. 13 and 14 provide bar graphs summarizing first and second field trial results based on percent weed control versus treatment, days after treatment and weeds controlled.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. An herbicidal combination, comprising:
a benzamide compound having a formula 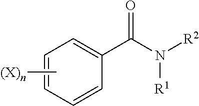
where R¹ is hydrogen or C₁-C₆ alkyl, R² is an aliphatic alkyne, X is halogen, and n=1-5; and
a pyridine carboxylic acid compound having a formula 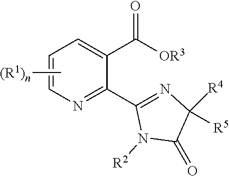
where R¹ is C₁₋₆ alkyl, R² is hydrogen or C₁₋₆ alkyl, n=1-3, R³ is hydrogen, a salt, or aliphatic, and R⁴ and R⁵ are independently C₁₋₆ alkyl.

2. The herbicidal combination according to claim 2 wherein the benzamide compound has a formula 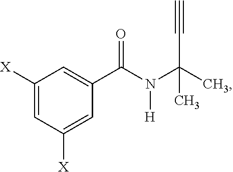
and the pyridine carboxylic acid compound has a formula

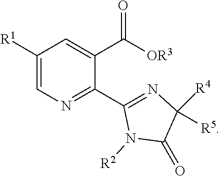

3. The combination according to claim 1 where the combination is a composition.

4. The composition according to claim 3 where the composition is a premix concentrate.

5. The composition according to claim 3 wherein, with reference to the benzamide compound, X chlorine, n is 2, R¹ is hydrogen, and/or R² is 1,1-dimethyl-2-propynyl.

6. The composition according to claim 3 wherein, with reference to the pyridine carboxylic acid compound, R¹ and R² are hydrogen or C₁₋₆ alkyl, n is 1, R³ is hydrogen, a cationic metal that forms a salt with the carboxylate functional group, an ammonium ion that forms a salt with the carboxylate functional group, a cationic organic compound that forms a salt with the carboxylate functional group, or C₁₋₆ alkyl, and/or R⁴ and R⁵ are independently C₁₋₆ alkyl.

7. The composition according to claim 3 wherein, with reference to the pyridine carboxylic acid compound, R¹ is ethyl, R² is hydrogen, R³ is hydrogen, R⁴ is isopropyl, and R⁵ is methyl.

8. The composition according to claim 3, comprising:
3,5-dichloro-n-(1,1-dimethyl-2-propynyl) benzamide (Pronamide) 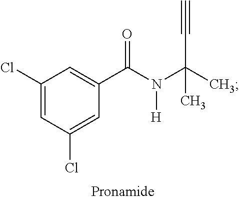 [SMILES: C#CC(C)(C)NC(=O)c1cc(Cl)cc(Cl)c1]
and
2-[4,5-dihydro-4-methyl-4-(1-methylethyl)-5-oxo-1H-imidazol-2-yl]-5-ethyl-3-pyridinecarboxylic acid (Imazethapyr)

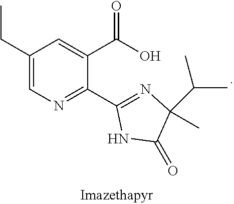 [SMILES: CCc1cnc(C2=NC(C)(C(C)C)C(=O)N2)c(C(=O)O)c1]

9. The composition according to claim 8 comprising a premix concentrate comprising from 1:1 to 1:12 by weight of Imazethapyr relative to Pronamide.

10. The composition according to claim 8 comprising 30 to 40 fluid ounces of Pronamide and 2 to 4 fluid ounces of Imazethapyr.

11. The composition according to claim 3 further comprising a pH adjustor, a surfactant, a safener, a dispersing agent, water, an organic co-solvent, an anti-freezing agent, a defoamer, a preservative, a filler, a rheology aid, an odorant, at least one additional co-herbicide, and any and all combinations thereof.

12. The composition according to claim 11 wherein the additional co-herbicide is an acetolactate synthase inhibitor, a protoporphyrinogen oxidase inhibitor, a synthetic auxin, a microtubule inhibitor, an acetyl-CoA carboxylase inhibitor, a photosystem II inhibitor, a pigment synthesis inhibitor, a VLCFA inhibitor, or any combination thereof.

13. The composition according to claim 11 wherein the additional co-herbicide is selected from ioxynil, aclonifen, acrolein, azafenidin, acifluorfen (including salts such as sodium), azimsulfuron, asulam, acetochlor, atrazine, anilofos, amicarbazone, amidosulfuron, amitrole, aminocyclopyrachlor, aminopyralid, amiprofos-methyl, ametryn, alachlor, alloxydim, ancymidol, isouron, isoxachlortole, isoxaflutole, isoxaben, Isodecylalkoholethoxylat, isoproturon, ipfencarbazone, imazaquin, imazapic (including salts such as amine), imazapyr (including salts such as isopropylamine), imazamethabenz-methyl, imazamox, imazosulfuron, indaziflam, indanofan, eglinazine-ethyl, esprocarb, ethametsulfuron-methyl, ethalfluralin, ethidimuron, ethoxysulfuron, ethoxyfen-ethyl, ethofumesate, etobenzanid, endothal-disodium, oxadiazon, oxadiargyl, oxaziclomefone, oxasulfuron, oxyfluorfen, oryzalin, orthosulfamuron, orbencarb, oleic acid, cafenstrole, carfentrazone-ethyl, karbutilate, carbetamide, quizalofop, quizalofop-ethyl, quizalofop-P-ethyl, quizalofop-P-tefuryl, quinoclamine, quinclorac, quinmerac, cumyluron, clacyfos, glyphosate (including salts such as sodium, potassium, amine, propylamine, isopropylamine, dimethylamine or trimesium), glufosinate (including salts such as amine or sodium), glufosinate-P, glufosinate-P-sodium, clethodim, clodinafop-propargyl, clopyralid, clomazone, chlomethoxyfen, clomeprop, cloransulam-methyl, chloramben, chloridazon, chlorimuron-ethyl, chlorsulfuron, chlorthal-dimethyl, chlorthiamid, chlorphthalim, chlorflurenol-methyl, chlorpropham, chlorbromuron, chloroxuron, chlorotoluron, ketospiradox (including salts such as sodium, calcium, or ammonia), saflufenacil, sarmentine, cyanazine, cyanamide, diuron, diethatyl-ethyl, dicamba (including salts such as amine, diethylamine, isopropylamine, diglycolamine, sodium or lithium), cycloate, cycloxydim, diclosulam, cyclosulfamuron, cyclopyrimorate, dichlobenil, diclofop-P-methyl, diclofop-methyl, dichlorprop, dichlorprop-P, diquat, dithiopyr, siduron, dinitramine, cinidon-ethyl, cinosulfuron, dinoseb, dinoterb, cyhalofop-butyl, diphenamid, difenzoquat, diflufenican, diflufenzopyr, simazine, dimethachlor, dimethametryn, dimethenamid, dimethenamid-P, simetryn, dimepiperate, dimefuron, cinmethylin, swep, sulcotrione, sulfentrazone, sulfosate, sulfosulfuron, sulfometuron-methyl, sethoxydim, terbacil, daimuron, thaxtomin A, dalapon, thiazopyr, tiafenacil, thiencarbazone (including sodium salt, methyl ester or the like), tiocarbazil, thiobencarb, thidiazimin, thidiazuron, thifensulfuron-methyl, desmedipham, desmetryne, thenylchlor, tebutam, tebuthiuron, tepraloxydim, tefuryltrione, terbuthylazine, terbutryn, terbumeton, tembotrione, topramezone, tralkoxydim, triaziflam, triasulfuron, triafamone, tri-allate, trietazine, triclopyr, triclopyr-butotyl, tritosulfuron, trifludimoxazin, triflusulfuron-methyl, trifluralin, trifloxysulfuron-sodium, tribenuron-methyl, tolpyralate, naptalam (including salts such as sodium), naproanilide, napropamide, napropamide-M, nicosulfuron, neburon, norflurazon, vernolate, paraquat dichloride, halauxifen-benzyl, halauxifen-methyl, haloxyfop, haloxyfop-P, haloxyfop-etotyl, halosafen, halosulfuron-methyl, picloram, picolinafen, bicyclopyrone, bispyribac-sodium, pinoxaden, bifenox, piperophos, pyraclonil, pyrasulfotole, pyrazoxyfen, pyrazosulfuron-ethyl, pyrazolynate, bilanafos, pyraflufen-ethyl, pyridafol, pyrithiobac-sodium, pyridate, pyriftalid, pyributicarb, pyribenzoxim, pyrimisulfan, pyriminobac-methyl, pyroxasulfone, pyroxsulam, phenisopham, fenuron, fenoxasulfone, fenoxaprop (including methyl, ethyl and isopropyl ester), fenoxaprop-P (including methyl, ethyl and isopropyl ester), fenthiaprop-ethyl, fentrazamide, phenmedipham, foramsulfuron, butachlor, butafenacil, butamifos, butylate, butenachlor, butralin, butroxydim, flazasulfuron, flamprop (including methyl, ethyl and isopropyl ester), flamprop-M (including methyl, ethyl and isopropyl ester), primisulfuron-methyl, fluazifop-butyl, fluazifop-P-butyl, fluazolate, fluometuron, fluoroglycofen-ethyl, flucarbazone-sodium, fluchloralin, flucetosulfuron, fluthiacet-methyl, flupyrsulfuron-methyl (including salts such as sodium, calcium or ammonia), flufenacet, flufenpyr-ethyl, flupropanate, flupoxame, flumioxazin, flumiclorac-pentyl, flumetsulam, fluridone, flurtamone, fluroxypyr (including esters such as butomethyl and meptyl, and salts such as sodium, calcium or ammonia), flurochloridone, pretilachlor, procarbazone-sodium, prodiamine, prosulfuron, prosulfocarb, propaquizafop, propachlor, propazine, propanil, propisochlor, propyrisulfuron, propham, profluazol, prohexadione-calcium, propoxycarbazone, propoxycarbazone-sodium, profoxydim, bromacil, brompyrazon, prometryn, prometon, bromoxynil (including esters such as butyric acid, octanoic acid or heptanoic acid), bromofenoxim, bromobutide, florasulam, florpyrauxifen, florpyrauxifen-benzyl, hexazinone, pethoxamid, benazolin, penoxsulam, heptamaloxyloglucan, beflubutamid, pebulate, pelargonic acid, bencarbazone, pendimethalin, benzfendizone, bensulide, bensulfuron-methyl, benzobicyclon, benzofenap, bentazone, pentanochlor, pentoxazone, benfluralin, benfuresate, fosamine, fomesafen, foramsulfuron, forchlorfenuron, mecoprop (including salts such as sodium, potassium, isopropylamine, triethanolamine or dimethylamine), mecoprop-P-potassium, mesosulfuron (including esters such as methyl), mesotrione, metazachlor, metazosulfuron, methabenzthiazuron, metamitron, metamifop, metam, DSMA, methiozolin, methyldymuron, metoxuron, metosulam, metsulfuron-methyl, metobromuron, metobenzuron, metolachlor, metribuzin, mepiquat chloride, mefenacet, monosulfuron (including methyl, ethyl and isopropyl ester), monolinuron, molinate, iodosulfuron, iodosulfulon-methyl-sodium, iofensulfuron, iofensulfuron-sodium, lactofen, lancotrione, linuron, rimsulfuron, lenacil, TCA (including salts such as sodium, calcium or ammonia), 2,3,6-TBA, 2,4,5-T, 2,4-D (including salts such as amine, diethylamine, triethanolamine, isopropylamine, sodium or lithium), ACN, AE-F-150944 (Code number), MCPA, MCPB (including sodium salt, ethyl ester or the like), 2,4-DB, DNOC (including salts such as amine or sodium), MCPA-thioethyl, IR-6396 (Code number), SYP-298 (Code number), SYP-300 (Code number), EPTC, S-metolachlor, S-9750 (Code number), MSMA, and HW-02 (Code number), 2,3,6-TBA, 2,3,6-TBA-dimethylammonium, 2,3,6-TBA-sodium, 2,4,5-T, 2,4,5-T-2-butoxypropyl, 2,4,5-T-2-ethylhexyl, 2,4,5-T-3-butoxypropyl, 2,4,5-TB, 2,4,5-T-butometyl, 2,4,5-T-butotyl, 2,4,5-T-butyl, 2,4,5-T-isobutyl, 2,4,5-T-isoctyl, 2,4,5-T-isopropyl, 2,4,5-T-methyl, 2,4,5-T-pentyl, 2,4,5-T-sodium, 2,4,5-T-triethylammonium, 2,4,5-T-trolamine, 2,4-D, 2,4-D-2-butoxypropyl, 2,4-D-2-ethylhexyl, 2,4-D-3-butoxypropyl, 2,4-D-ammonium, 2,4-DB, 2,4-DB-butyl, 2,4-DB-dimethylammonium, 2,4-DB-isoctyl, 2,4-DB-potassium, 2,4-DB-sodium, 2,4-D-butotyl, 2,4-D-butyl, 2,4-D-diethylammonium, 2,4-D-dimethylammonium, 2,4-D-diolamine, 2,4-D-dodecylammonium, 2,4-DEB, 2,4-DEP, 2,4-D-ethyl, 2,4-D-heptylammonium, 2,4-D-isobutyl, 2,4-D-isoctyl, 2,4-D-isopropyl, 2,4-D-isopropylammonium, 2,4-D-lithium, 2,4-D-meptyl, 2,4-D-methyl, 2,4-D-octyl, 2,4-D-pentyl, 2,4-D-potassium, 2,4-D-propyl, 2,4-D-sodium, 2,4-D-tefuryl, 2,4-D-tetradecylammonium, 2,4-D-triethylammonium, 2,4-D-tris(2-hydroxypropyl)ammonium, 2,4-D-trolamine, 3,4-DA, 3,4-DB, 3,4-DP, 4-CPA, 4-CPB, 4-CPP, acetochlor, acifluorfen, acifluorfen-methyl, acifluorfen-sodium, aclonifen, acrolein, alachlor, allidochlor, alloxydim, alloxydim-sodium, allyl alcohol, alorac, ametridione, ametryn, amibuzin, amicarbazone, amidosulfuron, aminocyclopyrachlor, aminocyclopyrachlor-methyl, aminocyclopyrachlor-potassium, aminopyralid, aminopyralid-potassium, aminopyralid-tris(2-hydroxypropyl)ammonium, amiprofos-methyl, amitrole, ammonium sulfamate, anilofos, anisuron, asulam, asulam-potassium, asulam-sodium, atraton, atrazine, azafenidin, azimsulfuron, aziprotryne, barban, BCPC, beflubutamid, benazolin, benazolin-dimethylammonium, benazolin-ethyl, benazolin-potassium, bencarbazone, benfluralin, benfuresate, bensulfuron, bensulfuron-methyl, bensulide, bentazone, bentazone-sodium, benzadox, benzadox-ammonium, benzfendizone, benzipram, benzobicyclon, benzofenap, benzofluor, benzoylprop, benzoylprop-ethyl, benzthiazuron, bicyclopyrone, bifenox, bilanafos, bilanafos-sodium, bispyribac, bispyribac-sodium, borax, bromacil, bromacil-lithium, bromacil-sodium, bromobonil, bromobutide, bromofenoxim, bromoxynil, bromoxynil butyrate, bromoxynil heptanoate, bromoxynil octanoate, bromoxynil-potassium, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, carfentrazone, carfentrazone-ethyl, CDEA, CEPC, chlomethoxyfen, chloramben, chloramben-ammonium, chloramben-diolamine, chloramben-methyl, chloramben-methylammonium, chloramben-sodium, chloranocryl, chlorazifop, chlorazifop-propargyl, chlorazine, chlorbromuron, chlorbufam, chloreturon, chlorfenac, chlorfenac-sodium, chlorfenprop, chlorfenprop-methyl, chlorflurazole, chlorflurenol, chlorflurenol-methyl, chloridazon, chlorimuron, chlorimuron-ethyl, chlornitrofen, chloropon, chlorotoluron, chloroxuron, chloroxynil, chlorprocarb, chlorpropham, chlorsulfuron, chlorthal, chlorthal-dimethyl, chlorthal-monomethyl, chlorthiamid, cinidon-ethyl, cinmethylin, cinosulfuron, cisanilide, clethodim, cliodinate, clodinafop, clodinafop-propargyl, clofop, clofop-isobutyl, clomazone, clomeprop, cloprop, cloproxydim, clopyralid, clopyralid-methyl, clopyralid-olamine, clopyralid-potassium, clopyralid-tris(2-hydroxypropyl)ammonium, cloransulam, cloransulam-methyl, CMA, copper sulfate, CPMF, CPPC, credazine, cresol, cumyluron, cyanamide, cyanatryn, cyanazine, cycloate, cyclosulfamuron, cycloxydim, cycluron, cyhalofop, cyhalofop-butyl, cyperquat, cyperquat chloride, cyprazine, cyprazole, cypromid, daimuron, dalapon, dalapon-calcium, dalapon-magnesium, dalapon-sodium, dazomet, dazomet-sodium, delachlor, desmedipham, desmetryn, di-allate, dicamba, dicamba-dimethylammonium, dicamba-diolamine, dicamba-isopropylammonium, dicamba-methyl, dicamba-olamine, dicamba-potassium, dicamba-sodium, dicamba-trolamine, dichlobenil, dichloralurea, dichlormate, dichlorprop, dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P-dimethylammonium, dichlorprop-potassium, dichlorprop-sodium, diclofop, diclofop-methyl, diclosulam, diethamquat, diethamquat dichloride, diethatyl, diethatyl-ethyl, difenopenten, difenopenten-ethyl, difenoxuron, difenzoquat, difenzoquat metilsulfate, diflufenican, diflufenzopyr, diflufenzopyr-sodium, dimefuron, dimepiperate, dimethachlor, dimethametryn, dimethenamid, dimethenamid-P, dimexano, dimidazon, dinitramine, dinofenate, dinoprop, dinosam, dinoseb, dinoseb acetate, dinoseb-ammonium, dinoseb-diolamine, dinoseb-sodium, dinoseb-trolamine, dinoterb, dinoterb acetate, diphacinone-sodium, diphenamid, dipropetryn, diquat, diquat dibromide, disul, disul-sodium, dithiopyr, diuron, DMPA, DNOC, DNOC-ammonium, DNOC-potassium, DNOC-sodium, DSMA, EBEP, eglinazine, eglinazine-ethyl, endothal, endothal-diammonium, endothal-dipotassium, endothal-disodium, epronaz, EPTC, erbon, esprocarb, ethalfluralin, ethametsulfuron, ethametsulfuron-methyl, ethidimuron, ethiolate, ethofumesate, ethoxyfen, ethoxyfen-ethyl, ethoxysulfuron, etinofen, etnipromid, etobenzanid, EXD, fenasulam, fenoprop, fenoprop-3-butoxypropyl, fenoprop-butometyl, fenoprop-butotyl, fenoprop-butyl, fenoprop-isoctyl, fenoprop-methyl, fenoprop-potassium, fenoxaprop, fenoxaprop-ethyl, fenoxaprop-P, fenoxaprop-P-ethyl, fenoxasulfone, fenteracol, fenthiaprop, fenthiaprop-ethyl, fentrazamide, fenuron, fenuron TCA, ferrous sulfate, flamprop, flamprop-isopropyl, flamprop-M, flamprop-methyl, flamprop-M-isopropyl, flamprop-M-methyl, flazasulfuron, florasulam, fluazifop, fluazifop-butyl, fluazifop-methyl, fluazifop-P, fluazifop-P-butyl, fluazolate, flucarbazone, flucarbazone-sodium, flucetosulfuron, fluchloralin, flufenacet, flufenican, flufenpyr, flufenpyr-ethyl, flumetsulam, flumezin, flumiclorac, flumiclorac-pentyl, flumioxazin, flumipropyn, fluometuron, fluorodifen, fluoroglycofen, fluoroglycofen-ethyl, fluoromidine, fluoronitrofen, fluothiuron, flupoxam, flupropacil, flupropanate, flupropanate-sodium, flupyrsulfuron, flupyrsulfuron-methyl-sodium, fluridone, flurochloridone, fluroxypyr, fluroxypyr-butometyl, fluroxypyr-meptyl, flurtamone, fluthiacet, fluthiacet-methyl, fomesafen, fomesafen-sodium, foramsulfuron, fosamine, fosamine-ammonium, furyloxyfen, glufosinate, glufosinate-ammonium, glufosinate-P, glufosinate-P-ammonium, glufosinate-P-sodium, glyphosate, glyphosate-diammonium, glyphosate-dimethylammonium, glyphosate-isopropylammonium, glyphosate-monoammonium, glyphosate-potassium, glyphosate-sesquisodium, glyphosate-trimesium, halosafen, halosulfuron, halosulfuron-methyl, haloxydine, haloxyfop, haloxyfop-etotyl, haloxyfop-methyl, haloxyfop-P, haloxyfop-P-etotyl, haloxyfop-P-methyl, haloxyfop-sodium, hexachloroacetone, hexaflurate, hexazinone, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazaquin-methyl, imazaquin-sodium, imazethapyr, imazethapyr-ammonium, imazosulfuron, indanofan, indaziflam, iodobonil, iodomethane, iodosulfuron, iodosulfuron-methyl-sodium, ioxynil, ioxynil octanoate, ioxynil-lithium, ioxynil-sodium, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-2-ethylhexyl, MCPA-butotyl, MCPA-butyl, MCPA-dimethylammonium, MCPA-diolamine, MCPA-ethyl, MCPA-isobutyl, MCPA-isoctyl, MCPA-isopropyl, MCPA-methyl, MCPA-olamine, MCPA-potassium, MCPA-sodium, MCPA-thioethyl, MCPA-trolamine, MCPB, MCPB-ethyl, MCPB-methyl, MCPB-sodium, mecoprop, mecoprop-2-ethylhexyl, mecoprop-dimethylammonium, mecoprop-diolamine, mecoprop-ethadyl, mecoprop-isoctyl, mecoprop-methyl, mecoprop-P, mecoprop-P-dimethylammonium, mecoprop-P-isobutyl, mecoprop-potassium, mecoprop-P-potassium, mecoprop-sodium, mecoprop-trolamine, medinoterb, medinoterb acetate, mefenacet, mefluidide, mefluidide-diolamine, mefluidide-potassium, mesoprazine, mesosulfuron, mesosulfuron-methyl, mesotrione, metam, metam-ammonium, metamifop, metamitron, metam-potassium, metam-sodium, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metolachlor, metosulam, metoxuron, metribuzin, metsulfuron, metsulfuron-methyl, molinate, monalide, monisouron, monochloroacetic acid, monolinuron, monuron, monuron TCA, morfamquat, morfamquat dichloride, MSMA, naproanilide, napropamide, naptalam, naptalam-sodium, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxapyrazon-dimolamine, oxapyrazon-sodium, oxasulfuron, oxaziclomefone, oxyfluorfen, parafluron, paraquat, paraquat dichloride, paraquat dimetilsulfate, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picloram-2-ethylhexyl, picloram-isoctyl, picloram-methyl, picloram-olamine, picloram-potassium, picloram-triethylammonium, picloram-tris(2-hydroxypropyl)ammonium, picolinafen, pinoxaden, piperophos, potassium arsenite, potassium azide, potassium cyanate, pretilachlor, primisulfuron, primisulfuron-methyl, procyazine, prodiamine, profluazol, profluralin, profoxydim, proglinazine, proglinazine-ethyl, prometon, prometryn, propachlor, propanil, propaquizafop, propazine, propham, propisochlor, propoxycarbazone, propoxycarbazone-sodium, propyrisulfuron, prosulfalin, prosulfocarb, prosulfuron, proxan, proxan-sodium, prynachlor, pydanon, pyraclonil, pyraflufen, pyraflufen-ethyl, pyrasulfotole, pyrazolynate, pyrazosulfuron, pyrazosulfuron-ethyl, pyrazoxyfen, pyribenzoxim, pyributicarb, pyriclor, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quinonamid, quizalofop, quizalofop-ethyl, quizalofop-P, quizalofop-P-ethyl, quizalofop-P-tefuryl, rhodethanil, rimsulfuron, saflufenacil, sebuthylazine, secbumeton, sethoxydim, siduron, simazine, simeton, simetryn, SMA, S-metolachlor, sodium arsenite, sodium azide, sodium chlorate, sulcotrione, sulfallate, sulfentrazone, sulfometuron, sulfometuron-methyl, sulfosulfuron, sulfuric acid, sulglycapin, swep, TCA, TCA-ammonium, TCA-calcium, TCA-ethadyl, TCA-magnesium, TCA-sodium, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone, thiencarbazone-methyl, thifensulfuron, thifensulfuron-methyl, thiobencarb, tiocarbazil, tioclorim, topramezone, tralkoxydim, tri-allate, triasulfuron, triaziflam, tribenuron, tribenuron-methyl, tricamba, triclopyr, triclopyr-butotyl, triclopyr-ethyl, triclopyr-triethylammonium, tridiphane, trietazine, trifloxysulfuron, trifloxysulfuron-sodium, trifluralin, triflusulfuron, triflusulfuron-methyl, trifop, trifop-methyl, trifopsime, trihydroxytriazine, trimeturon, tripropindan, tritac, tritosulfuron, vernolate, or xylachlor; and wherein the herbicide safener is selected from benoxacor, cloquintocet-mexyl, cyprosulfamide, dichlormid, fenchlorazole-ethyl, fenclorim, fluxofenim, furilazole and the corresponding R isomer, isoxadifen-ethyl, mefenpyr-diethyl, oxabetrinil, N-isopropyl-4-(2-methoxy-benzoylsulfamoyl)-benzamide, and N-(2-methoxybenzoyl)-4-[(methylaminocarbonyl)amino]benzenesulfonamide, as well as salts and analogues of these compounds.

14. The composition according to claim 11, comprising at least one additional co-herbicide selected from 2,4-D, acetochlor, metolachlor, metolachlor S, azoxystrobin, azoxystrobin plus metalaxyl, azoxystrobin plus propiconazole, bromoxynil, carfentrazone, clopyralid, flucarbazone, flumetsulam, fluroxypyr, fluroxypyr plus clopyralid, imazamox, imazethapyr, imazamox plus imazethapyr, imidacloprid, cyhalothrin, lamba-cyhalothrin, MCPA, prothioconazole, tebuconazole, metalaxyl, metalaxyl plus tebuconazole and prothioconazole, pinoxaden, pinoxaden plus cloquintocet, propiconazole, pyraclostrobin, pyroxasulfone, quinclorac, atrazine, acetochlor plus atrazine, trifloxystrobin, prothioconazole plus trifloxystrobin, metconazole, boscalid, mesotrione, atrazine plus mesotrione plus metolachlor S, bentazon, bentazon plus imazamox, boscalid plus prothioconazole, flucarbazone, metconazole-pyraclostrobin, metolachlor-s-metribuzin, saflufenacil, atrazine-metolachlor-s, fluroxypyr-2,4-d, flumioxazin, metconazole+pyraclostrobin 58.69%, fluroxypyr-florasulam-mcpa, prothioconazole-trifloxystrobin, pendimethalin, fluroxypyr-clopyralid-mcpa ester, fomesafen-metolachlor-s, prothioconazole-tebuconazole, quizalofop, ethalfluralin, fomesafen-glyphosate, tembotrione, tribenuron, isoxaflutole, thifensulfuron-tribenuron, bromoxynil-mcpa ester, topramezone, ethephon, fenoxaprop-p, pyroxsulam, prothioconazole+tebuconazole+metalaxyl, sulfentrazone, pyraclostrobin, thiencarbazone, bromoxynil-pyrasulfotole-thiencarbazone-methyl, pyrasulfotole-fenoxaprop-p-bromoxynil, bromoxynil-pyrasulfatole, bromoxynil-pyrasulfotole, pyrasulfotole-thiencarbazone-bromoxynil, tembotrione-thiencarbazone-methyl, isoxaflutole-thiencarbazone-methyl, and abamectin.

15. The composition according to claim 11, comprising Glyphosate (N-(phosphonomethyl)glycine), Pendimethalin (3,4-Dimethyl-2,6-dinitro-N-pentan-3-yl-aniline), or both.

16. The composition according to claim 11, comprising an additional alfalfa product for pre- or post-application selected from Buctril (5-dibromo-4-hydroxybenzonitrile), (2,4-DB (4-(2,4-dichlorophenoxy)butanoic acid)), POAST (sethoxydim active agent, (2-[1-(ethoxyimino)butyl]-5-[2-(ethylthio)propyl]-3-hydroxy-2-cyclohexen-1-one), POAST PLUS (sethoxydim), Prism (rimsulfuron, (1-(4,6-dimethoxypyrimidin-2-yl)-3-(3-ethylsulfonyl-2-pyridylsulfonyl)urea) and Select (clethodim, (2-[(Z)—N-[(E)-3-chloroprop-2-enoxy]-C-ethylcarbonimidoyl]-5-(2-ethylsulfanylpropyl)-3-hydroxycyclohex-2-en-1-one)).

17. The composition according to claim 8, comprising from 38 wt. % to 39 wt. % water; 1 wt. % to 2 wt. % hexylene glycol; 0.1 wt. % to 1 wt. % xanthan gum; 0.1 wt. % to 1 wt. % aciticide; 0.1 wt. % to 1 wt. % SAG 1572; 20 wt. % to 30 wt. % AU-760B; 33 wt. % to 35 wt. % Pronamide; and 1 wt. % to 2 wt. % Imazethapyr.

18. A method, comprising applying a combination according to claim 1 to a locus where undesired vegetation is present or may be present.

19. The method according to claim 18 comprising using a premix concentrate or a tank mix composition comprising Pronamide and Imazethapyr.

20. The method according to claim 19 comprising applying a composition to control the growth of broadleafs, grass weeds and sedges.

21. The method according to claim 20 wherein the composition is applied to alfalfa or mixed on or in a field comprising alfalfa.

22. A method, comprising forming a premix concentrate or a tank mix comprising an effective amount of at least (1) a benzamide compound having a formula 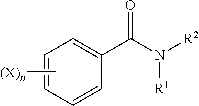
where R¹ is hydrogen or C₁-C₆ alkyl, R² is an aliphatic alkyne, X is halogen, and n=1 or 2, and (2) a pyridine carboxylic acid compound having a formula 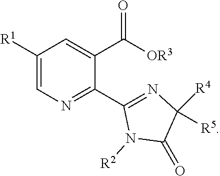
where R¹ is alkyl, R² is hydrogen or alkyl, R³ is hydrogen, a salt, or aliphatic, and R⁴ and R⁵ are independently C₁₋₆ alkyl.

23. The method according to claim 22 wherein the benzamide is 3,5-dichloro-n-(1,1-dimethyl-2-propynyl) benzamide (Pronamide) 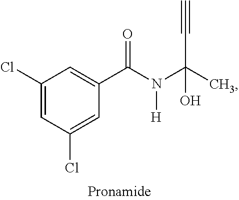 [SMILES: C#CC(C)(O)NC(=O)c1cc(Cl)cc(Cl)c1]
and the pyridine carboxylic acid is 2-[4,5-dihydro-4-methyl-4-(1-methylethyl)-5-oxo-1H-imidazol-2-yl]-5-ethyl-3-pyridinecarboxylic acid (Imazethapyr) 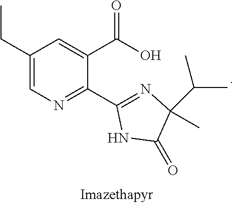 [SMILES: CCc1cnc(C2=NC(C)(C(C)C)C(=O)N2)c(C(=O)O)c1]
